(19) United States
(12) Patent Application Publication
(10) Pub. No.: US 2026/0047623 A1
(43) Pub. Date: Feb. 19, 2026

(54) GLOVE HAVING DRUG-DETECTION COATING

(71) Applicant: Summit Glove Inc., Minerva, OH (US)

(72) Inventor: James L. HULL, Malvern, OH (US)

(73) Assignee: Summit Glove Inc., Minerva, OH (US)

(21) Appl. No.: 19/370,950

(22) Filed: Oct. 28, 2025

Related U.S. Application Data
(62) Division of application No. 18/785,675, filed on Jul. 26, 2024.

(51) Int. Cl. A41D 19/00; G01N 21/78

(52) U.S. Cl. CPC A41D 19/0024; G01N 21/78

(57) ABSTRACT

A glove and method of detecting a toxic substance on a surface is disclosed. A coating is applied over an exterior surface of at least a portion of the glove. The coating is formulated to detect toxic substances when the glove is donned and brought into contact with an object or surface. In particular, the coating may be formulated to detect toxic substances such as opioids and drug mixtures which include opioids. The coating may be applied over substantially the entire exterior surface of the glove or as coated regions formed on the palm region and/or digit regions of the glove. When the glove is brought into direct physical contact with the toxic substance it is formulated to detect, at least one characteristic of the coating changes. In some instances, the coating will change color when the toxic substance is contacted.

### TECHNICAL FIELD

This disclosure relates generally to gloves and more particularly to gloves such as those worn by medical professionals and first responders. Specifically, the present disclosure relates to a glove having an exterior surface upon which a coating is applied. Specifically, the coating is applied to at least a portion of the exterior surface of the glove, particularly gripping areas thereof, and the coating is capable of detecting and/or resisting drugs, particularly opioids or drug mixtures which include opioids.

### BACKGROUND ART

Medical personnel and first responders may come into contact with harmful and/or toxic substances when treating a patient, particularly during an emergency. These harmful or toxic substances such as illicit drugs laced with opioids such as fentanyl and carfentinal can cause injury to or severe illness in the medical personnel or first responders. In order to try and avoid these harmful or toxic substances, medical personnel or first responders will wear gloves and are trained to handle patients extremely carefully to try and avoid contact with these harmful or toxic substances.

One of the problems experienced by those treating people who are experiencing some type of medical emergency is that it is difficult to impossible for medical personnel or first responders to know if the person they are treating has been taking illicit drugs. Another problem is that even if the medical personnel or first responders realize that illicit drugs are at least a factor in the medical emergency, the patient may not be capable of communicating what type of drugs are involved.

### SUMMARY OF THE INVENTION

A glove and a method of detecting a toxic substance on a surface are disclosed herein. A coating is applied over an exterior surface of at least a portion of the glove. The coating is formulated to detect toxic substances when the glove is donned and brought into contact with an object or surface. In particular, the coating may be formulated to detect toxic substances such as opioids and drug mixtures which include opioids. The coating may be applied over substantially the entire exterior surface of the glove or as coated regions formed on the palm region and/or digit regions of the glove. When the glove is brought into direct physical contact with the toxic substance it is formulated to detect, at least one characteristic of the coating changes. In some instances, the coating will change color when the toxic substance is contacted.

In one aspect, an exemplary embodiment of the present disclosure may provide a glove comprising a wrist region; a palm region extending outwardly from the wrist region; a plurality of digit regions extending outwardly from the palm region; wherein the glove has an interior surface and an exterior surface; a coating applied to at least a portion of the exterior surface of the glove; wherein the coating is formulated to detect a drug.

In one embodiment, the coating is formulated to detect an opioid or a compound including an opioid. In one embodiment, the coating is formulated to detect one or more of fentanyl, carfentanil, and mixtures of drugs including fentanyl or carfentanil. In one embodiment, the coating is further formulated to indicate that the drug has been detected. In one embodiment, the coating changes in at least one characteristic when the drug has been detected. In one embodiment, the coating changes in color when the drug has been detected.

In one embodiment, the coating applied to the exterior surface forms a coated region on one or more of the palm region and the plurality of digit regions. In one embodiment, the coated region is provided on the palm region on one or both of a front and a back of the glove. In one embodiment, the coated region is provided on one digit region of the plurality of digit regions on one or both of a front and a back of the glove. In one embodiment, the coated region is provided on two digit regions of the plurality of digit regions on one or both of a front and a back of the glove. In one embodiment, the coated region is provided on three digit regions of the plurality of digit regions on one or both of a front and a back of the glove. In one embodiment, the coated region is provided on four digit regions of the plurality of digit regions on one or both of a front and a back of the glove. In one embodiment, the coated region is provided on each digit region of the plurality of digit regions on one or both of a front and a back of the glove.

In one embodiment, at least one digit region of the plurality of digit regions includes a fingertip region which extends from proximate a tip of the at least one digit region to proximate where a first knuckle of a person's thumb or finger will be located when the glove is worn; wherein the fingertip region is of a reduced circumference relative to a circumference of a remaining portion of the at least one digit region, and wherein the coating forms a coated region on the fingertip region on one or both of a front and a back of the glove. In one embodiment, at least one digit region of the plurality of digit regions includes an upper portion which extends from proximate a tip of the at least one digit region to proximate where a first knuckle of a person's thumb or finger will be located when the glove is worn; and wherein the coating forms a coated region on the upper portion on one or both of a front and a back of the glove.

In one embodiment, the coating is applied over substantially the entire exterior surface of the glove. In one embodiment, the glove is an ambidextrous glove. In one embodiment, the glove is a hand-specific glove. In one embodiment, the glove is fabricated from a glove material which is opioid resistant. In one embodiment, the glove is fabricated from a glove material which is not opioid resistant.

In one embodiment, glove material of the wrist region, palm region, thumb region, index finger region, middle finger region, ring finger region and little finger region is free of or is essentially free of elements, components and compounds that cause hypersensitivity and allergic reaction in a person who wears the glove. In one embodiment, glove material of the wrist region, palm region, thumb region, index finger region, middle finger region, ring finger region and little finger region is free of or is essentially free of zinc and/or sulfur and/or accelerants. In one embodiment, the interior surface of the glove is of a first color and the exterior surface of the glove is of a second color which is different from the first color.

In another aspect, an exemplary embodiment of the present disclosure may provide a method of detecting a toxic substance on a surface comprising providing a glove having an exterior surface; formulating a coating capable of detecting the toxic substance; applying the coating over at least a portion of the exterior surface of the glove; donning the glove; contacting the surface with the portion of the exterior surface of the glove having the coating applied thereto; and changing a characteristic of the coating to indicate the presence of the toxic substance.

In one embodiment, formulating the coating includes formulating a coating capable of detecting an opioid or mixtures including an opioid. In one embodiment, applying the coating includes forming a coated region on a gripping surface of the glove. In one embodiment, applying the coating includes forming a coated region on one or more of a palm region and a digit region of the glove. In one embodiment, changing the characteristic of the coating includes changing a color of the coating from a first color to a second color when the toxic substance is detected.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a perspective view of a first example of a first embodiment of a glove in accordance with the present disclosure;

FIG. 2 is a front elevation view of the glove of FIG. 1;

FIG. 3 is a rear elevation view thereof;

FIG. 4 is a cross section through a middle finger region of the glove, taken along line 4-4 of FIG. 2;

FIG. 5A is second example of the first embodiment glove shown in FIG. 1;

FIG. 5B is a third example of the first embodiment glove shown in FIG. 1;

FIG. 5C is a fourth example of the first embodiment glove shown in FIG. 1; and

FIG. 5D is a fifth example of the first embodiment glove shown in FIG. 1;

FIG. 6 is a perspective view of a first example of a second embodiment of a glove in accordance with the present disclosure;

FIG. 7 is a front elevation view of the glove of FIG. 6;

FIG. 8 is a rear elevation view thereof;

FIG. 9A is second example of the second embodiment glove shown in FIG. 6;

FIG. 9B is a third example of the second embodiment glove shown in FIG. 6;

FIG. 9C is a fourth example of the second embodiment glove shown in FIG. 6; and

FIG. 9D is a fifth example of the second embodiment glove shown in FIG. 6;

FIG. 10 is a perspective view of a first example of a third embodiment of a glove in accordance with the present disclosure;

FIG. 11 is a front elevation view of the glove of FIG. 10;

FIG. 12 is a rear elevation view thereof;

FIG. 13A is second example of the third embodiment glove shown in FIG. 10;

FIG. 13B is a third example of the third embodiment glove shown in FIG. 10;

FIG. 13C is a fourth example of the third embodiment glove shown in FIG. 10; and

FIG. 13D is a fifth example of the third embodiment glove shown in FIG. 10;

FIG. 14 is a perspective view of a first example of a fourth embodiment of a glove in accordance with the present disclosure;

FIG. 15 is a front elevation view of the glove of FIG. 14;

FIG. 16 is a rear elevation view thereof;

FIG. 17A is second example of the fourth embodiment glove shown in FIG. 14;

FIG. 17B is a third example of the fourth embodiment glove shown in FIG. 14;

FIG. 17C is a fourth example of the fourth embodiment glove shown in FIG. 14; and

FIG. 17D is a fifth example of the fourth embodiment glove shown in FIG. 14;

FIG. 18 is a perspective view of a first example of a fifth embodiment of a glove in accordance with the present disclosure;

FIG. 19 is a front elevation view of the glove of FIG. 18;

FIG. 20 is a rear elevation view thereof;

FIG. 21A is second example of the fifth embodiment glove shown in FIG. 18;

FIG. 21B is a third example of the fifth embodiment glove shown in FIG. 18;

FIG. 21C is a fourth example of the fifth embodiment glove shown in FIG. 18; and

FIG. 21D is a fifth example of the fifth embodiment glove shown in FIG. 18;

FIG. 22 is a perspective view of a first example of a sixth embodiment of a glove in accordance with the present disclosure;

FIG. 23 is a front elevation view of the glove of FIG. 22;

FIG. 24 is a rear elevation view thereof;

FIG. 25A is second example of the sixth embodiment glove shown in FIG. 22;

FIG. 25B is a third example of the sixth embodiment glove shown in FIG. 22;

FIG. 25C is a fourth example of the sixth embodiment glove shown in FIG. 22; and

FIG. 25D is a fifth example of the sixth embodiment glove shown in FIG. 22;

FIG. 26 is a perspective view of a first example of a seventh embodiment of a glove in accordance with the present disclosure;

FIG. 27 is a front elevation view of the glove of FIG. 26; and

FIG. 28 is a rear elevation view thereof;

FIG. 29 is a perspective view of a first example of an eighth embodiment of a glove in accordance with the present disclosure;

FIG. 30 is a front elevation view of the glove of FIG. 29; and

FIG. 31 is a rear elevation view thereof;

FIG. 32 is a perspective view of a first example of a ninth embodiment of a glove in accordance with the present disclosure;

FIG. 33 is a front elevation view of the glove of FIG. 32;

FIG. 34 is a rear elevation view thereof;

FIG. 35 is a cross section through a middle finger region of the ninth embodiment glove, taken along line 35-35 of FIG. 33;

FIG. 36A is second example of the ninth embodiment glove shown in FIG. 32;

FIG. 36B is a third example of the ninth embodiment glove shown in FIG. 32;

FIG. 36C is a fourth example of the ninth embodiment glove shown in FIG. 32; and

FIG. 36D is a fifth example of the ninth embodiment glove shown in FIG. 32;

FIG. 37 is a perspective view of a first example of a tenth embodiment of a glove in accordance with the present disclosure;

FIG. 38 is a front elevation view of the glove of FIG. 37;

FIG. 39 is a rear elevation view thereof;

FIG. 40A is second example of the tenth embodiment glove shown in FIG. 37;

FIG. 40B is a third example of the tenth embodiment glove shown in FIG. 37;

FIG. 40C is a fourth example of the tenth embodiment glove shown in FIG. 37; and

FIG. 40D is a fifth example of the tenth embodiment glove shown in FIG. 37;

FIG. 41 is a perspective view of a first example of an eleventh embodiment of a glove in accordance with the present disclosure;

FIG. 42 is a front elevation view of the glove of FIG. 41;

FIG. 43 is a rear elevation view thereof;

FIG. 44A is second example of the eleventh embodiment glove shown in FIG. 41;

FIG. 44B is a third example of the eleventh embodiment glove shown in FIG. 41;

FIG. 44C is a fourth example of the eleventh embodiment glove shown in FIG. 41; and

FIG. 44D is a fifth example of the eleventh embodiment glove shown in FIG. 41;

FIG. 45 is a perspective view of a first example of a twelfth embodiment of a glove in accordance with the present disclosure;

FIG. 46 is a front elevation view of the glove of FIG. 45;

FIG. 47 is a rear elevation view thereof;

FIG. 48A is second example of the twelfth embodiment glove shown in FIG. 45;

FIG. 48B is a third example of the twelfth embodiment glove shown in FIG. 45;

FIG. 48C is a fourth example of the twelfth embodiment glove shown in FIG. 45; and

FIG. 48D is a fifth example of the twelfth embodiment glove shown in FIG. 45;

FIG. 49 is a perspective view of a first example of a thirteenth embodiment of a glove in accordance with the present disclosure;

FIG. 50 is a front elevation view of the glove of FIG. 49;

FIG. 51 is a rear elevation view thereof;

FIG. 52A is second example of the thirteenth embodiment glove shown in FIG. 49;

FIG. 52B is a third example of the thirteenth embodiment glove shown in FIG. 49;

FIG. 52C is a fourth example of the thirteenth embodiment glove shown in FIG. 49; and

FIG. 52D is a fifth example of the thirteenth embodiment glove shown in FIG. 49;

FIG. 53 is a perspective view of a first example of a fourteenth embodiment of a glove in accordance with the present disclosure;

FIG. 54 is a front elevation view of the glove of FIG. 53;

FIG. 55 is a rear elevation view thereof;

FIG. 56A is second example of the fourteenth embodiment glove shown in FIG. 53;

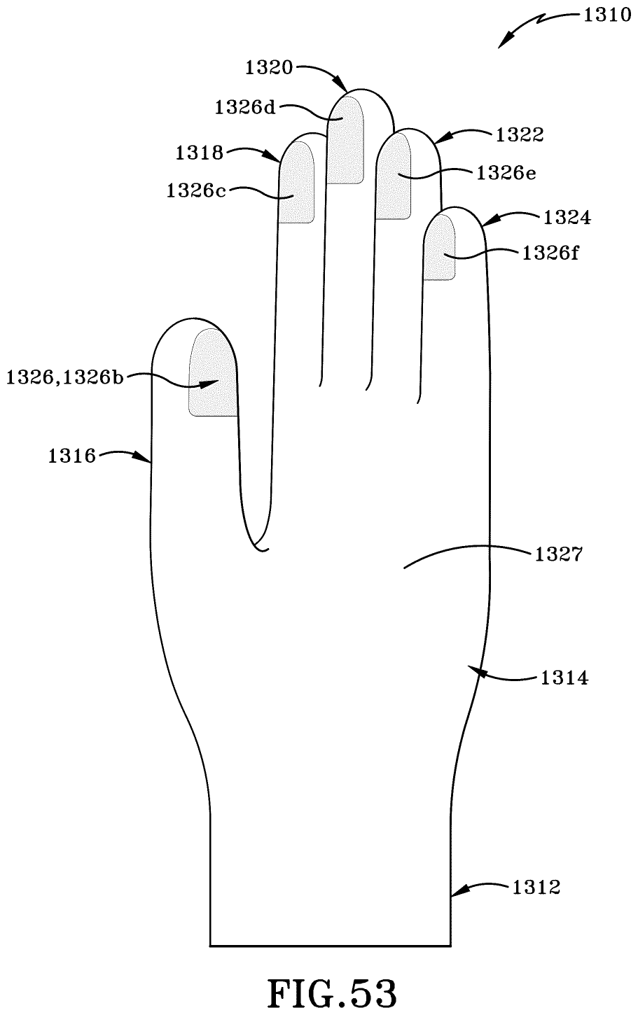

FIG. 53;

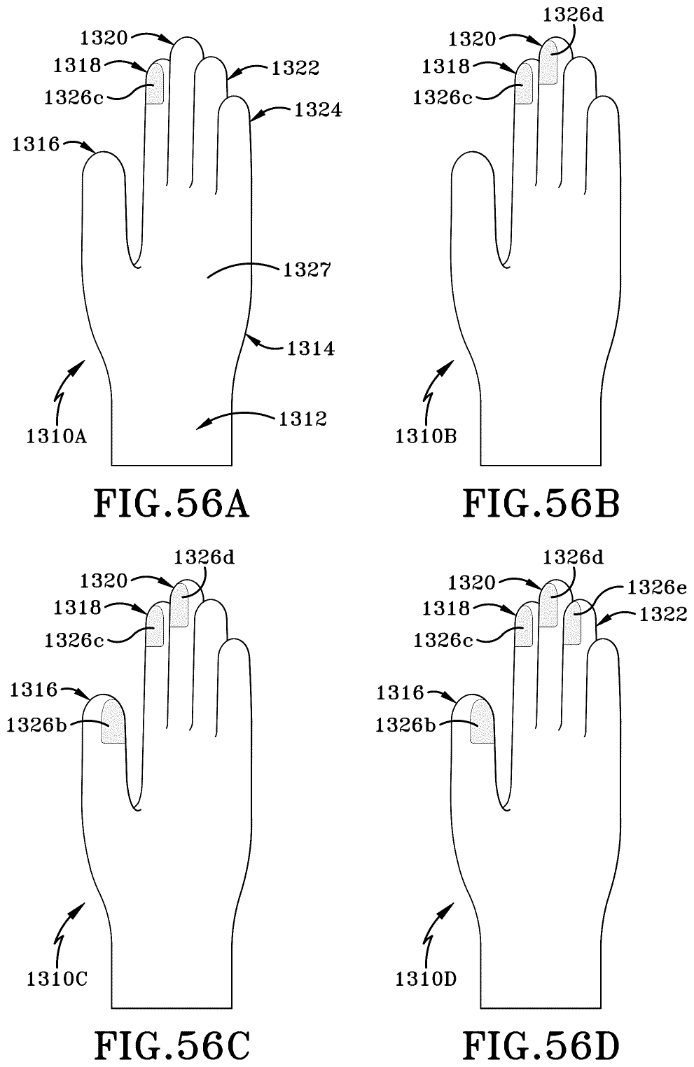

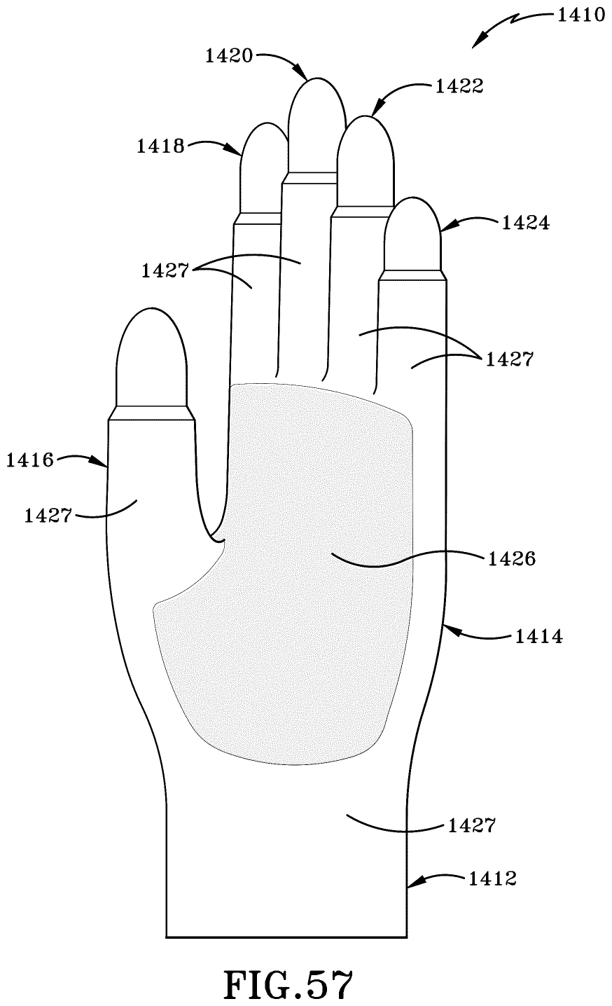

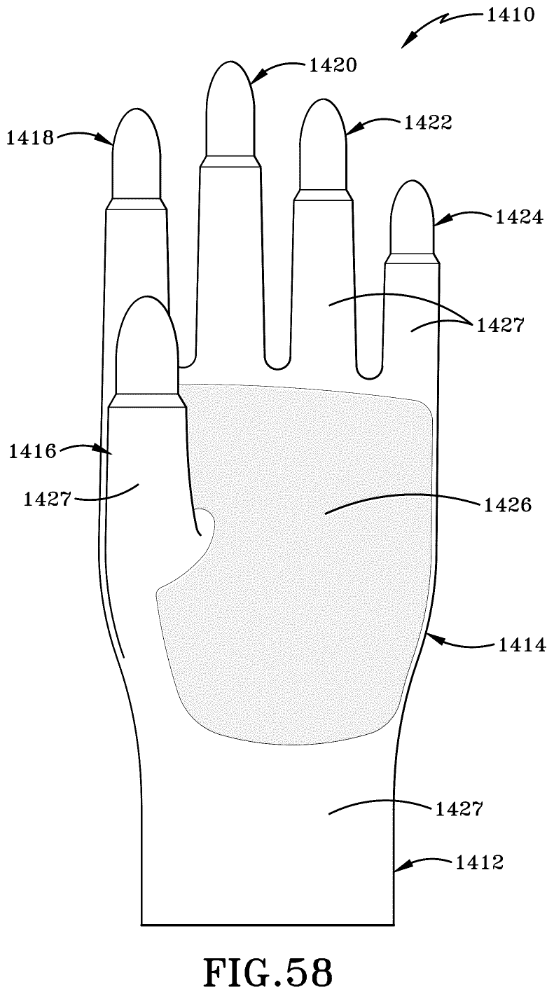

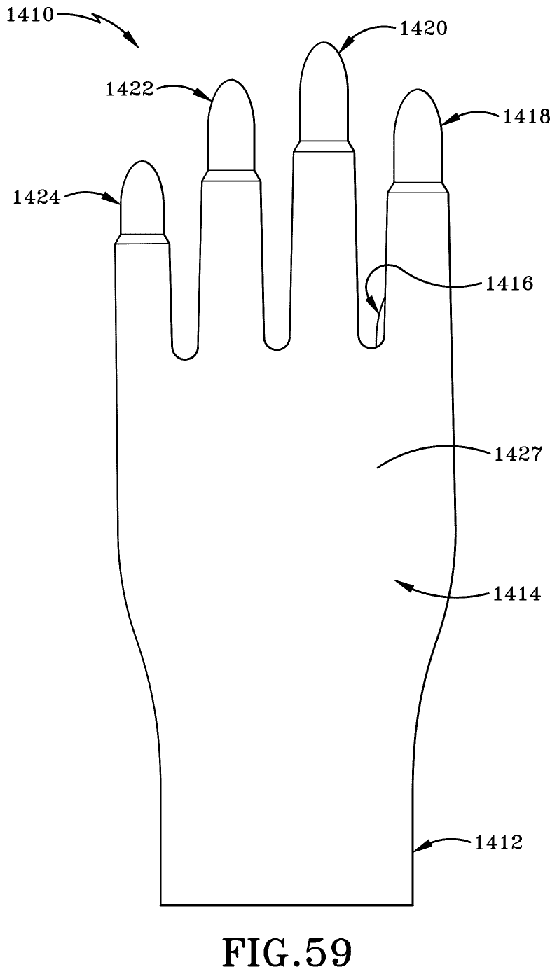

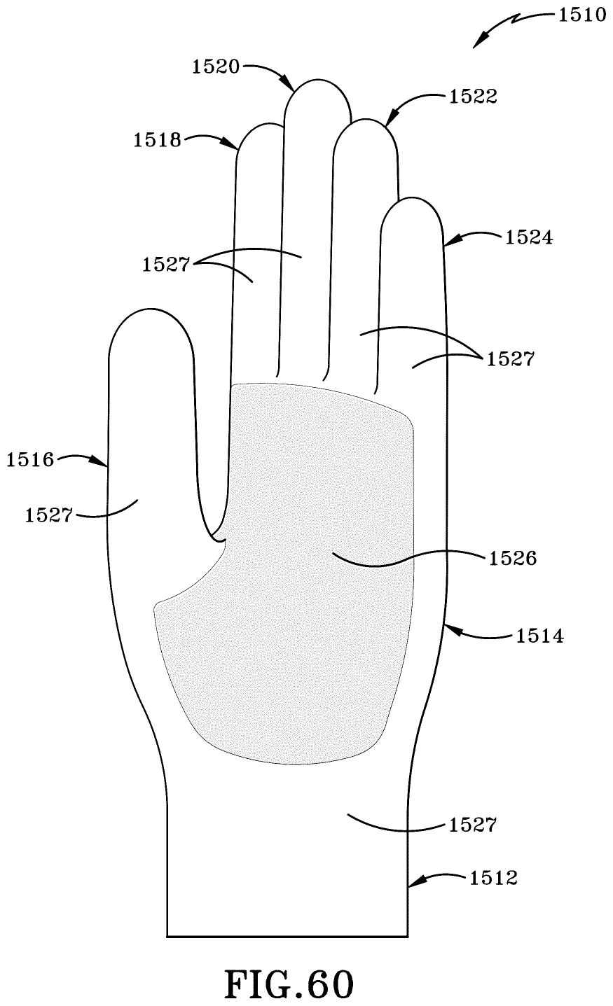

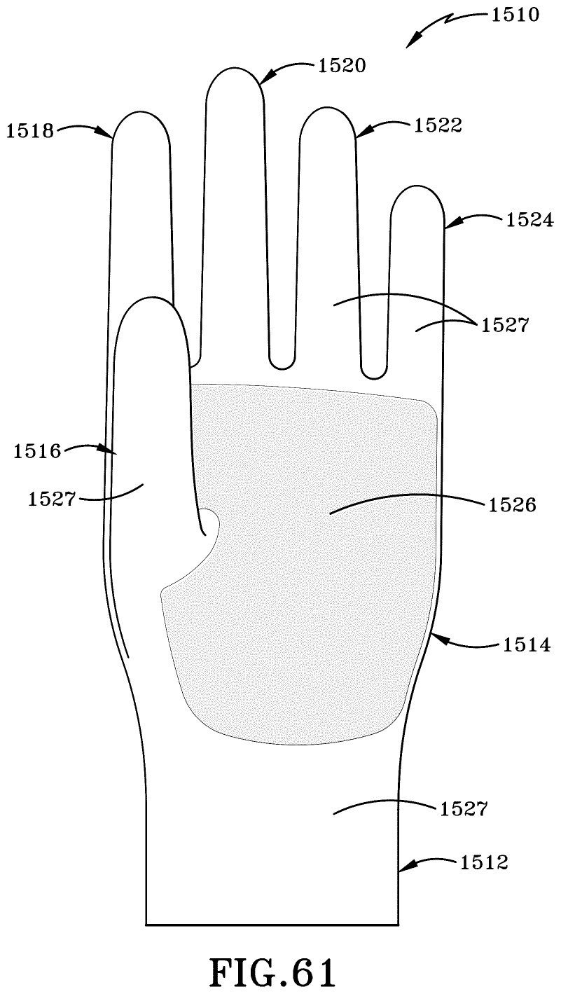

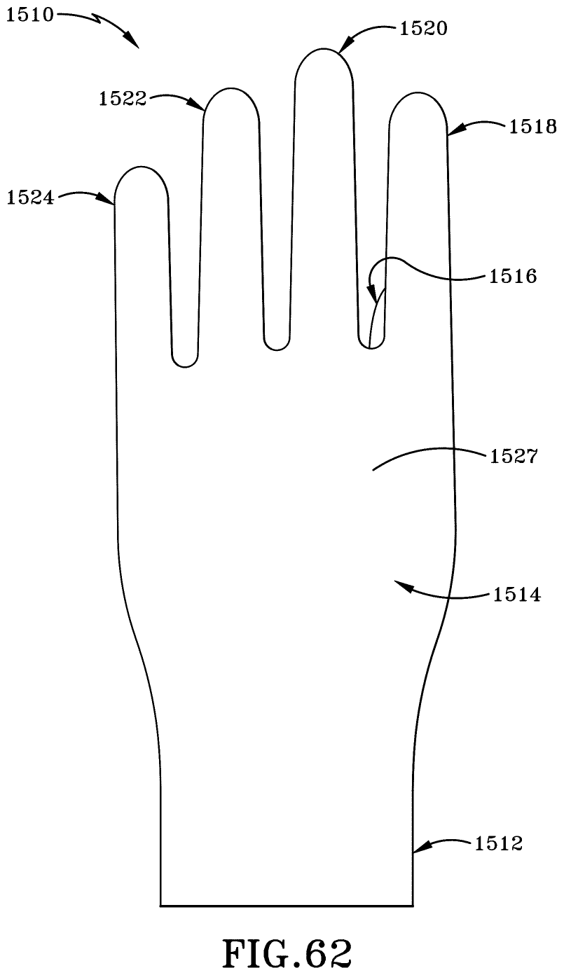

FIG. 56B is a third example of the fourteenth embodiment glove shown in FIG. 53; and

FIG. 56C is a fourth example of the fourteenth embodiment glove shown in FIG. 56D is a fifth example of the fourteenth embodiment glove shown in FIG. 53;

FIG. 57 is a perspective view of a first example of a fifteenth embodiment of a glove in accordance with the present disclosure;

FIG. 58 is a front elevation view of the glove of FIG. 57; and

FIG. 59 is a rear elevation view thereof;

FIG. 60 is a perspective view of a first example of a sixteenth embodiment of a glove in accordance with the present disclosure;

FIG. 61 is a front elevation view of the glove of FIG. 60; and

FIG. 62 is a rear elevation view thereof.

Similar numbers refer to similar parts throughout the drawings.

### DETAILED DESCRIPTION

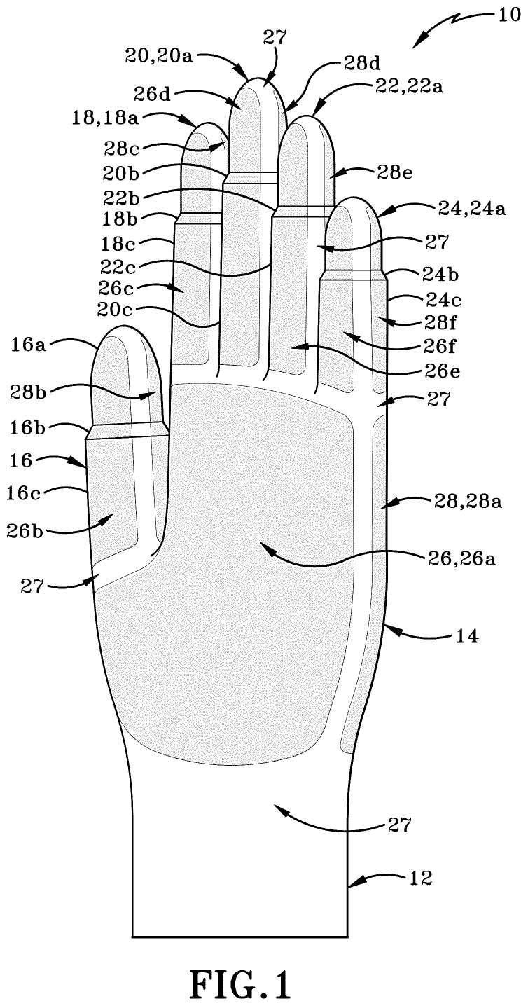

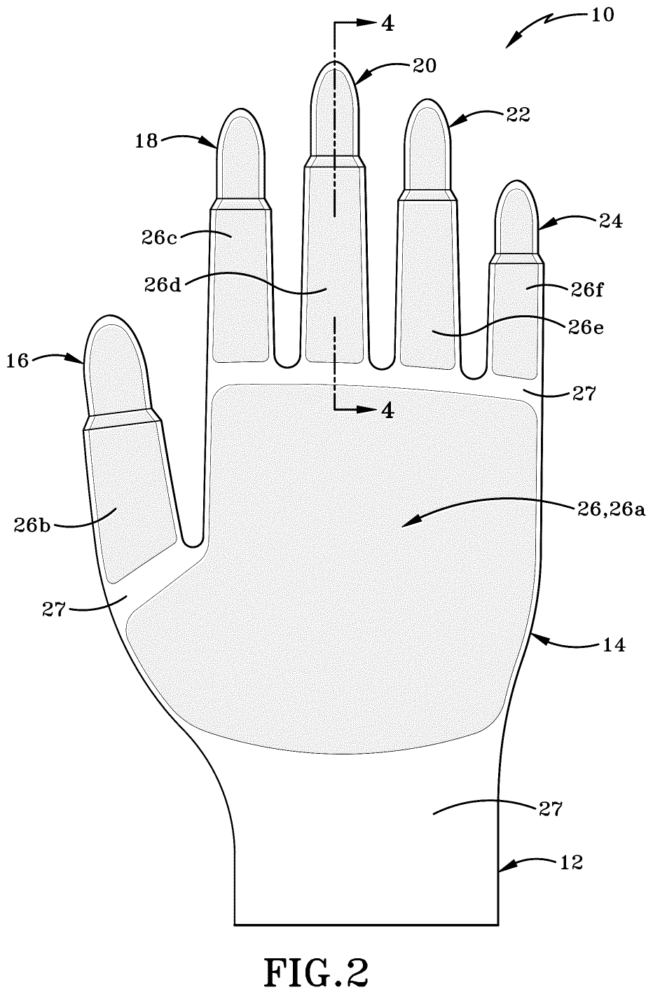

Referring now to FIGS. 1-5D there is shown a first example of a first embodiment of a glove in accordance with the present disclosure, generally indicated at 10. Glove 10 comprises a wrist region 12, a palm region 14, a thumb region 16, an index finger region 18, a middle finger region 20, a ring finger region 22, and a little finger region 24. Glove 10 defines an interior cavity (not numbered) which is configured to receive a hand of a person therein. Thumb region 16, index finger region 18, middle finger region 20, ring finger region 22, and little finger region 24 comprise digit regions which are configured to receive an associated one of a thumb, an index finger, a middle finger, a ring finger, and a little finger of the person's hand, respectively. Palm region 14 is configured to receive the person's palm therein when glove 10 is worn. The palm region 14 includes a first surface which will be located adjacent those regions of a person's palm which will contact an object when gripped in the person's hand. The palm region further includes a second surface which will be located adjacent the back of the person's hand. The term “palm region” 14 as used herein is therefore contemplated to encompass both of the first and second surface which will be located adjacent the front and back of the person's hands. Glove 10 also includes two opposed sides of glove 10 which extend between the first and second surface of the palm region 14.

Wrist region 12 is that portion of glove 12 which will cover the person's wrist and, in some embodiments, part of the forearm of the person when glove 12 is worn. The degree to which the wrist and forearm of the person are covered by wrist region 12 is dependent upon the length of the wrist region 12 as measured from the palm region through to a cuff or rolled rim at a lowermost edge of glove 10. A longer length wrist region 12 will cover the wrist and at least part of the forearm of the person wearing the glove. A shorter length wrist region 12 may only just cover the person's wrist. The length of the wrist region 12 will be varied according to the intended final use of glove 12. Consequently, it should be understood that the particular length wrist region 12 shown in the attached figures is exemplary only and shorter or longer wrist regions 12 may be provided on other embodiments of the glove 10.

Glove 10 as illustrated in FIGS. 1-5D is an ambidextrous glove which is capable of being worn on either of a left hand or a right hand of the person. In the ambidextrous glove 10 each of the thumb region 16, index finger region 18, middle finger region 20, ring finger region 22, and little finger region 24 are aligned along a common plane (not numbered).

As illustrated in each of FIGS. 1-5D, each digit region of glove 10 is comprised of a fingertip region and a remaining portion. The fingertip region originates in a tip of the respective digit region and extends downwardly towards palm region 14 for a distance. The distance is of a length such that the fingertip region will generally be located adjacent to or near where a first knuckle of the person's associated thumb or finger will be when glove 10 is worn. The remaining portion extends between the fingertip region and the palm region 14. The fingertip region of each digit region is of a reduced circumference relative to remaining portion 20b. As illustrated, the remaining portion includes a transition portion which tapers in circumference moving in a direction from the remaining portion of the digit region towards the respective fingertip region thereof.

As illustrated in FIG. 1, thumb region 16 includes a fingertip region 16a, a transition portion 16b, and a remaining portion 16c. Index finger region 18 includes a fingertip region 18a, a transition region 16b, and a remaining portion 18c. Middle finger region 20 includes fingertip region 20a, a transition region 20b, and a remaining portion 20c. Ring finger region 22 includes a fingertip region 22a, a transition region 20b, and a remaining portion 22c. Little finger region 24 includes a fingertip region 24a, a transition region 24b, and remaining portion 24c.

FIGS. 1-5D show each of the fingertip regions 16a, 18a, 20a, 22a, and 24a is of a reduced circumference relative to the associated remaining portions 16c, 18c, 20c, 22c, and 24c. Most particularly, the fingertip regions 16a, 18a, 20a, 22a, and 24a are of a “bullet-tip” shape. A bullet-tip shaped fingertip region provided on a glove is described in detail in U.S. Pat. No. 10,602,788 (Hull), which patent is incorporated herein by reference. It should be understood that other configurations of the digit regions which result in a reduced-circumference configuration of the fingertip region may be provided on the digit regions of glove 10 instead of the illustrated bullet-tip configuration.

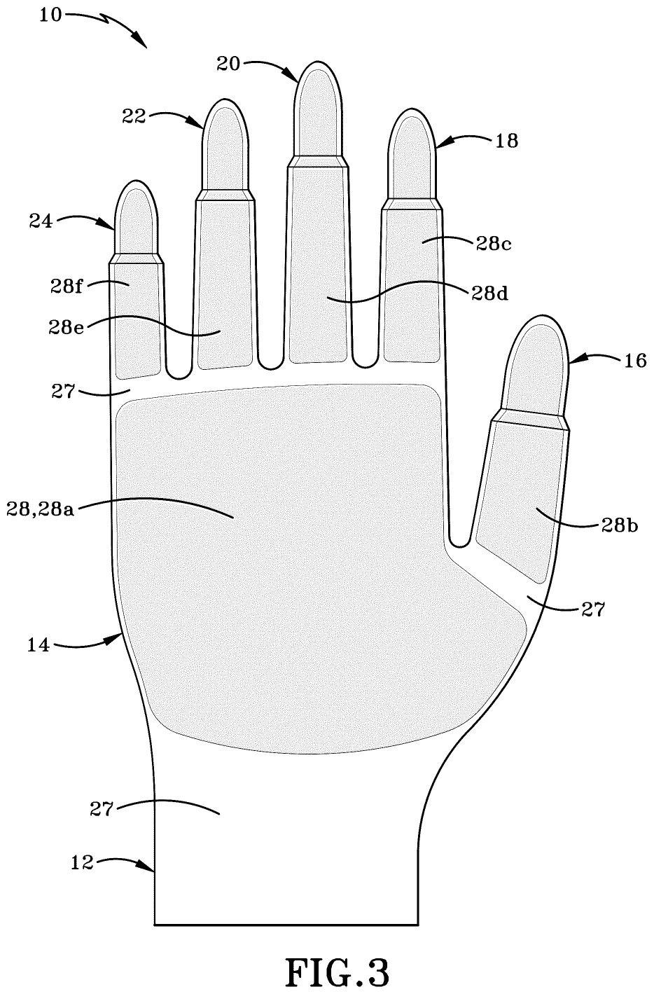

When glove 10 is worn on the left hand as illustrated in FIG. 1, the surface of the glove facing the viewer is considered, for the purposes of this description, to be the “front” surface of the glove 10. The front of the glove is that part of the glove which will contact an object held in a left hand of a person while wearing the glove. Because FIG. 1 shows a “front” view, the surfaces of the wrist region 12, palm region 14, and digit regions facing the viewer of FIG. 1 may be considered to be the “front” surface of the respective one of the wrist region 12, palm region 14, and digit regions 16, 18, 20, 22, and 24. FIG. 3 then illustrates a “back” surface of the glove. Consequently, the surface of the wrist region 12, palm region 14, and digit regions facing the viewer in FIG. 3 may be considered to be the “back” surface of each of the wrist region 12, palm region 14, and digit regions 16, 18, 20, 22, and 24, for the purposes of this description. Furthermore, it will be understood that the sides of the wrist region 12, palm region 14, and digit regions 16-24 extending between the front and back of the glove 10 will be considered to be either a left side (first side) or right side (second side) of the respective component parts of the glove 10 for the purposes of this description. For example, FIG. 1 shows the right side (second side) of the various component parts of glove 10.

It should be noted that the terms “front”, “back”, “left”, and “right” are used for ease of description and particularly describe the specific orientation of the glove 10 illustrated in FIGS. 1 through 3. The terms “front”, “back”, “left”, and “right” should therefore not be narrowly construed to necessarily describe the orientation of the glove 10 during use, particularly since glove 10 is an ambidextrous glove and can be worn on either of the left hand or right hand of a user.

The glove 10 disclosed herein is fabricated from any suitable glove material such as nitrile, nitrile rubber, or natural rubber. The glove material preferably is free of or essentially free of zinc and/or sulfur and/or fluoride, and/or cross-links, and/or accelerators and/or accelerants. Some accelerators/accelerants that the glove's material may be free of or essentially free of may include carbonates or thiurams. The glove material which is free of or essentially free of zinc and/or sulfur and/or fluoride, and/or cross-links, and/or accelerators and/or accelerants will at least comprise a portion of the glove which will contact the user's skin when the glove is worn. The composition of the disclosed glove may tend to reduce hypersensitivity or allergic reactions in populations which may be required to frequently wear protective gloves, such as medical practitioners. Additionally, glove 10 may have an exterior surface of one color and an interior surface of another color, particularly a strongly contrasting color. This difference in color between the interior and exterior surfaces of the glove may act as a tear or cut indicator since, if the interior color is visible on the exterior of the glove, the person wearing the glove will realize that the exterior surface has been compromised in some way.

In accordance with an aspect of the present disclosure and as will be discussed in greater detail later herein, a coating or layer overlays at least a portion of glove 10. The coating or layer is specially formulated to be capable of detecting toxic or corrosive substances when glove 10 is brought in contact therewith. The coating or layer preferably is specially formulated to be capable of detecting drugs, particularly those drugs which are opioid drugs or drugs that include opioids. The opioids that the coating is capable of detecting include, but is not limited to, fentanyl, carfentanil, heroin (diacetylmorphine), morphine, oxycodone, buprenorphine, methadone, hydrocodone (dihydrocodeinone), meperidine, codeine, tramadol, and oxymorphone. The glove material may furthermore be formulated to detect drugs such as xylazine or xylazine mixed with an opioid. (Xylazine is a non-opioid sedative or tranquilizer.)

Not only is the coating capable of detecting the opioids and toxic drugs as discussed above, but the coating is capable of indicating to the person wearing the glove and to others that the glove 10 has been brought into contact with the opioid or other toxic drug. In one embodiment, the coating is capable of changing color and/or or texture when brought into contact with the toxic or corrosive drug or chemical. For example, the exterior surface of glove 10 may be of a first color and the drug-detecting coating or layer may also be of the first color prior to coming into contact with the drug or toxic substance the coating is formulated to detect. However, when the glove 10 is worn and is brought into contact with the drug or toxic substance, the coating may change color and/or may change in texture. For example, the coating may change from a first color to a second color when the drug or chemical is contacted. The second color is preferably one which contrasts with the first color so that the second color is readily apparent. Additionally or alternatively, the coating may change from a first texture to a second texture when the drug or toxic chemical is contacted. For example, the entire glove 10, including the coated regions, may be smooth before the drug or chemical is contacted. Once the drug or chemical is contacted, the coated regions may change in texture and become roughly textured. Any suitable manner of indicating that the coated regions of the glove 10 have come into contact with the drug or toxic chemical can be utilized and is within the scope of the present disclosure.

Glove 10 may additionally be provided with a wear indicator or damage indicator. The wear or damage indicator will enable the person wearing the glove 10 or observing the glove 10 to readily and easily visually detect that the glove 10 is worn or damaged to the point the glove needs to be replaced. The wear indicator or damage indicator in one embodiment comprises fabricating the exterior surface of the glove 10 in one color and fabricating the coated regions so they will display the second color when contact is made with the drug or toxic chemical, and fabricating the interior surface of the glove in a third color which contrasts with both of the first color and the second color. If the second color becomes visible on the exterior surface of the glove 10, the person wearing the glove 10 will be made aware that they have come into physical contact with a dangerous substance. This indicates to the person wearing the glove 10 that special precautions need to be taken when handling a patient or when moving around an accident scene, for example. If the third color becomes visible on the glove 10, the person wearing the glove 10 will be made aware of the fact that the glove has been damaged. This indicates to the person wearing the glove 10 that it is time to replace the damaged glove.

Referring still to FIGS. 1-5D, glove 10 includes a coating which is applied over an exterior surface of glove 10. The coating in question is formulated to detect toxic substances such as drugs, particularly illicit drugs. The toxic substances may include but are not limited to opioids and drug mixtures including opioids. The coating is further formulated to indicate that the toxic substance has been detected. For example, the coating can be formulated to change in at least one characteristic when direct physical contact is made with the toxic substance which the coating is formulated to detect. In yet other instances, the coating may additionally or alternatively be formulated to be resistant to the toxic substance it is formulated to detect. For example, if the coating is formulated to detect fentanyl, the coating itself may be resistant to fentanyl or may at least hinder fentanyl from penetrating the glove material and contacting the skin of a person wearing the glove.

In particular, the coating is applied over substantially the entire exterior surface of the glove 10. The coating is applied in plurality of coated regions, each of which is capable of detecting and indicating the presence of dangerous drugs and chemicals to the person wearing the glove 10. In particular, coated regions, generally indicated by the reference number 26, are provided on the front of the glove 10. Palm region 14 includes a first coated region 26a which covers the gripping surface of palm region 14. The gripping surface is that part of palm region 14 which will contact an object held in the hand of a person while wearing glove 10. The front surface of thumb region 16 includes a second coated region 26b, the front surface of index finger region 18 includes a third coated region 26c, the front surface of middle finger region 20 includes a fourth coated region 26d; the front surface of ring finger region 22 includes a fifth coated region 26e, and the front surface of little finger region 24 includes a sixth coated region 26f. Each of the coated regions 26b through 26f extends from proximate the palm region 14 of glove 10 to proximate a tip of the associated thumb region or finger region.

Since glove 10 is an ambidextrous glove that is able to be worn on either of a left hand or a right hand of a person, both the front and the back of the glove 10 are able to be used to grip an object. As a consequence, the back surface of glove 10 also includes a plurality of coated regions that are able to detect opioids and other toxic chemicals and drugs. In particular, the back of palm region 14 includes a first coated region 28a, the back of thumb region 16 includes a second coated region 28b, the back of index finger region 18 includes a third coated region 28c, the back of middle finger region 20 includes a fourth coated region 28d, the back of ring finger region 22 includes a fifth coated region 28d, and the back of little finger region 24 includes a sixth coated region 28e. Each of the coated regions 28a through 28f is located in a substantially identical located on the back of the glove 10 to where the corresponding coated regions 26a through 26f are located on the front of glove 10.

It should be noted that a region free of the opioid/drug detected coating is located between first coated regions 26a, 28a on palm region 14 and the second coated regions 26b, 28b on thumb region 16. The region which is free of the coating is indicated by the reference number 27. Similarly, a coating-free region 27 is provided between the third coated regions 26c, 28c on index finger region 18 and first coated regions 26a, 28a on the front and back of palm region 14, and between the fourth coated regions 26d, 28d on middle finger region 20 and first coated regions 26a, 28a; and between the fifth coated regions 26e, 28e on ring finger region 22 and first coated regions 26a, 28a; and between the sixth coated regions 26f, 28f on little finger region 24 and first coated regions 26a, 28a on the front and back of palm region 14. The left and right sides of each of the thumb region 16, index finger region 18, middle finger region 20, ring finger region 22, and little finger region 24 are all free of the coating layer. The coating free regions 27 are substantially continuous with one another.

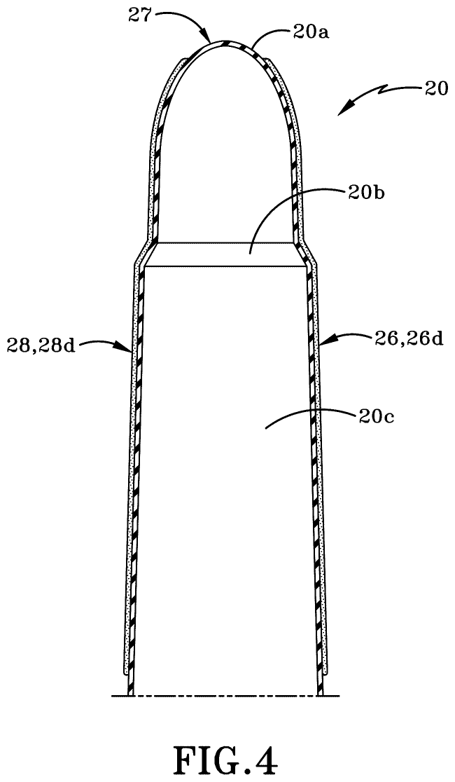

FIG. 4 shows a cross section of middle finger region 20 showing the fourth coated regions 26d, 28d located, respectively, on an exterior surface of the front and back surfaces of middle finger region 20. The coated regions 26d, 28d are separate layers which are applied over the exterior surface of the front and back surfaces of the middle finger region 20 and are bonded thereto. The tip of middle finger region 20 is free of coating layer and is therefore a coating free region 27. A cavity 20c is defined by an interior surface of middle finger region 20. When the glove 10 is worn, cavity 20c receives a person's middle finger therein. The coated regions 26a through 26f and 28a through 28f are all similarly configured to the fourth coated regions 26d, 28d illustrated in FIG. 4.

It should be noted that substantially the entire front surface and back surface of each of the thumb region 16 and finger regions 18-24 is coated with the coating layer. In particular, the fingertip region, the transition region, and the remaining portion of each of the thumb region 16 and finger regions 18-24 is coated with the coating layer.

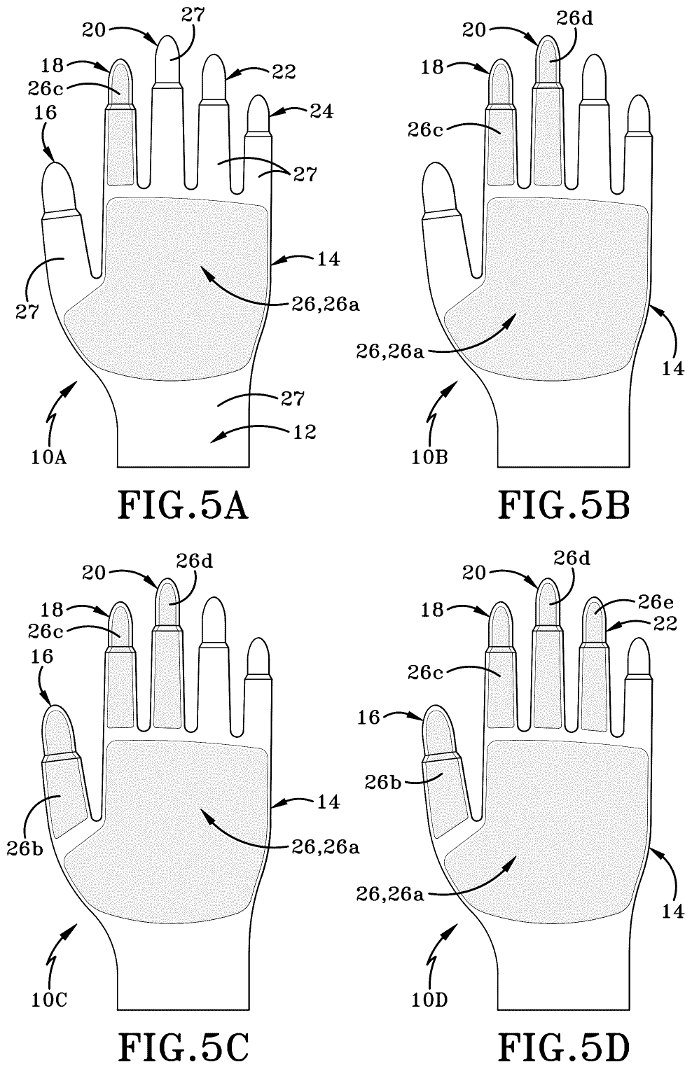

FIGS. 5A through 5D show alternative examples of the first embodiment glove 10, generally indicated as gloves 10A through 10D. FIGS. 5A through 5D show only the front of the alternative examples of the gloves 10A through 10D. The back of gloves 10A through 10D is not illustrated in the attached figures but should be understood to be substantially identical in configuration, structure, and placement of the various coated regions to the front thereof. FIG. 5A shows a second example of the first embodiment glove, generally indicated at 10A. Glove 10A includes a first coated region 26a on palm region 14 and a third coated region 26c on index finger region 18. The rest of exterior surface of the front of glove 10A is free of any coating layer. It will be understood that while glove 10A shows a coated region on the palm region 14 and on the index finger region 18, in other embodiments any other one of the digit regions may have a coated region thereon instead of index finger region 18.

Glove 10B (FIG. 5B) shows a third example of the first embodiment glove and includes first coated region 26a on palm region 14, a third coated region 26c on index finger region 18, and a fourth coated region 26d on middle finger region 20. The rest of the exterior surface of the front of glove 10B is free of any coating layer. It will be understood that while glove 10A shows a coated region on the palm region 14 and on the index finger region 18 and middle finger region, in other embodiments any other two of the digit regions may have a coated region thereon instead of index finger region 18 and middle finger region 20.

FIG. 5C shows a fourth example of the first embodiment glove, generally indicated at 10C. Glove 10C includes a first coated region 26a on palm region 14, a second coated region 26b on thumb region 16, a third coated region 26c on index finger region 18, and a fourth coated region on middle finger region 20. The rest of the exterior surface of the front of glove 10C is free of any coating layer. It will be understood that while glove 10A shows a coated region on the palm region 14 and on the thumb region 16, the index finger region 18, and the middle finger region 20, in other embodiments any other three of the digit regions may be provided with coated regions thereon.

Glove 10D (FIG. 5D) includes a first coated region 26a on palm region 14, a second coated region 26b on thumb region 16, a third coated region 26c on index finger region 18, a fourth coated region 26d on middle finger region 20, and a fifth coated region 26e on ring finger region 22. The rest of the front of gloves 10D is free of coating regions thereon and is indicated by the reference number 27. It will be understood that while glove 10A shows a coated region on the palm region 14 and on the thumb region 16, the index finger region 18, the middle finger region 20, and the ring finger region 22, in other embodiments any other combination of four of the digit regions may be provided with coated regions thereon.

The backs of the gloves 10A through 10D are substantially identical to the fronts thereof. The uncoated regions of gloves 10A through 10D are indicated by the reference number 27. Gloves 10A through 10D are substantially identical in all other aspects of construction and function to glove 10.

Glove 10 is used by pulling the same onto a hand of a user. The user is then able to grip objects, contact surfaces, and handle patients or victims which may be suspected to have a trace or a quantity of an unidentified substance thereon. In particular, it may be suspected that opioid drugs, particularly dangerous opioids such as fentanyl, may be present on the object, surface of person. The user will grip the object, contact the surface or brush their palm and/or fingers over a person's body or clothing. Specifically, the user will cause the coated regions 26a through 26f (or 28a through 28f) to contact the object, surface or person. The user will then break contact with the object, surface or person and visually observe whether a change has occurred in one of more coated regions 26a through 26f (or 28a through 28f) of glove 10. If, for example, the one or more coated regions 26a through 26g (or 28a through 28f) has changed or is beginning to change in color, then the user will know that a dangerous drug or other toxic chemical is present on the object, surface, or person and can take appropriate precautions and/or corrective action.

In one embodiment a method of detecting a toxic substance on a surface comprises providing a glove 10 having an exterior surface; formulating a coating 26 capable of detecting the toxic substance; applying the coating 26 over at least a portion of the exterior surface of the glove 10; donning the glove 10; contacting the surface with the portion of the exterior surface of the glove 10 having the coating 26 applied thereto; and changing a characteristic of the coating 26 to indicate the presence of the toxic substance. Formulating the coating 26 may include formulating a coating capable of detecting an opioid or mixtures including an opioid. Applying the coating 26 forming a coated region 26a, 26b, 26c, 26d, 26e, 26f, 28a, 28b, 28c, 28d, 28e, 28f on one or more of a palm region 14 and a digit region 16, 18, 20, 22, and 24 of the glove 26. Changing the characteristic of the coating 26 may include changing a color of the coating 26 from a first color to a second color when the toxic substance is detected.

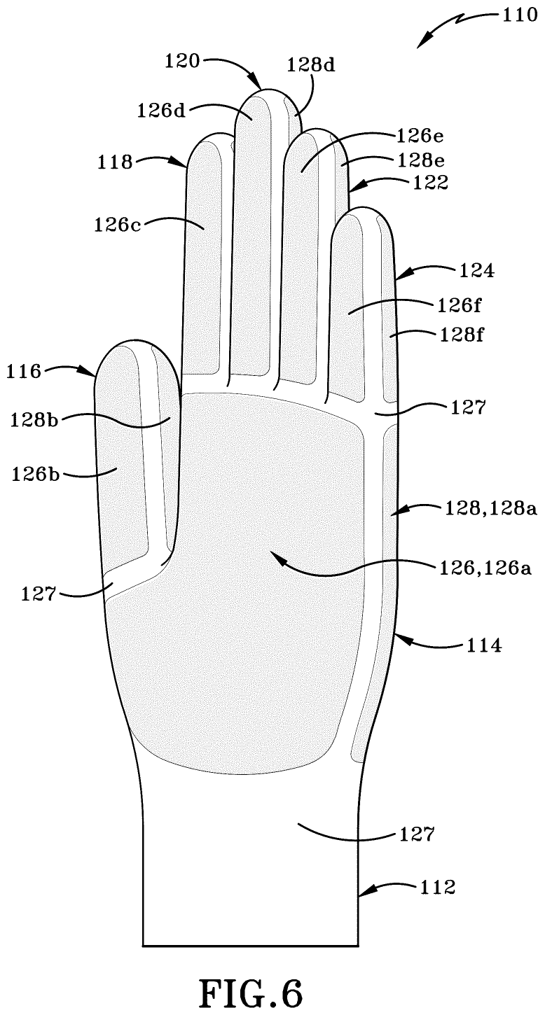

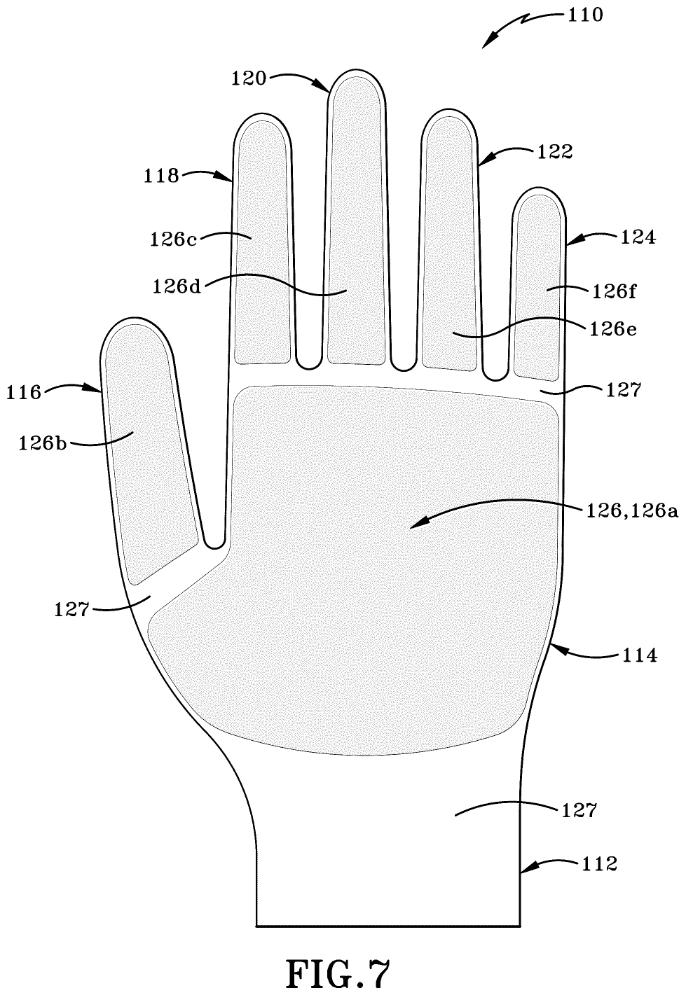

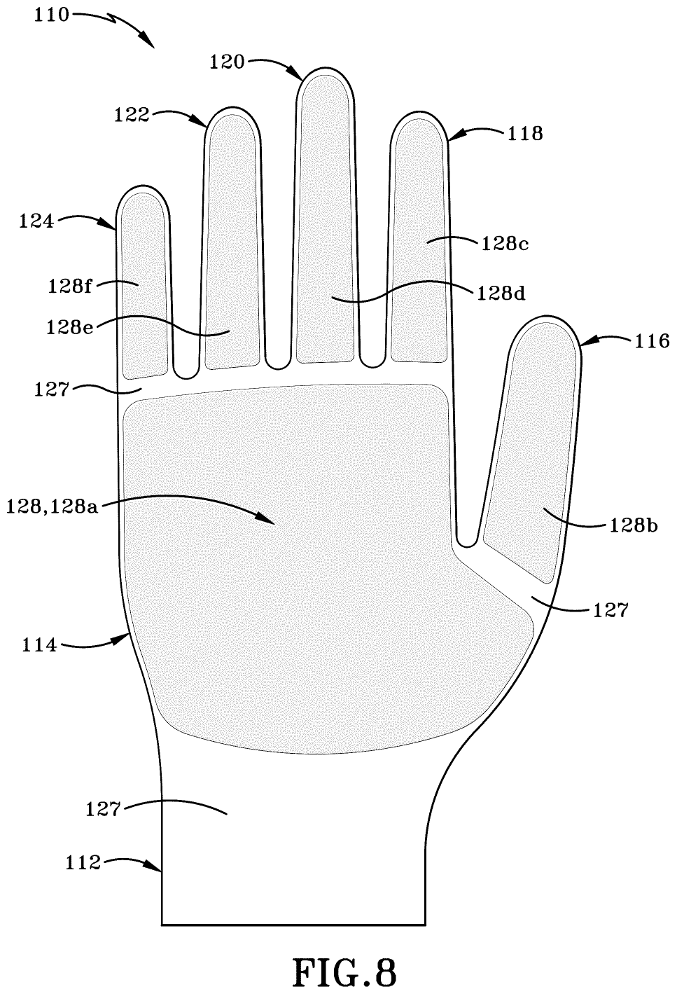

Referring now to FIGS. 6 to 9D there is shown a second embodiment of a glove in accordance with the present disclosure, generally indicated by the reference number 110. Glove 110 is substantially identical in structure and function to glove 10 except for the differences discussed hereafter. Glove 110 comprises a wrist region 112, a palm region 114, a thumb region 116, an index finger region 118, a middle finger region 120, a ring finger region 122, and a little finger region 124. Glove 110 defines an interior cavity (not numbered) which is configured to receive a hand of a person therein. The palm region 114 includes a front which will be located adjacent those regions of a person's palm which will contact an object when gripped in the person's hand.

Glove 110, like glove 10, is an ambidextrous glove which is capable of being worn on either of a left hand or a right hand of the person. Unlike glove 10, the digit regions 116 through 124 of glove 110 do not have a fingertip region, a transition region and a remaining portion defined therein. In particular, each digit region 116 through 124 of glove does not have a fingertip region which is narrower in circumference than a remaining portion of that digit region nor do the digit regions include a transition region which flares in circumference from the fingertip region to the remaining portion thereof. Instead, each of the digit regions 116 through 124 is of a substantially constant circumference from proximate palm region 114 through to the tip of the associate digit region 116 through 124.

Referring still to FIGS. 6-9D, glove 110 includes a plurality of coated regions which are capable of detecting and indicating the presence of dangerous drugs and chemicals to the person wearing the glove 110. In particular, coated regions, generally indicated by the reference number 126, are provided on the front of the glove 110. Palm region 114 includes a first coated region 126a which covers the gripping surface of palm region 114. The front surface of thumb region 116 includes a second coated region 126b, the front surface of index finger region 118 includes a third coated region 126c, the front surface of middle finger region 120 includes a fourth coated region 126d; the front surface of ring finger region 122 includes a fifth coated region 126e, and the front surface of little finger region 124 includes a sixth coated region 126f. Each of the coated regions 126a through 126f is formed and located on the front of glove 110 in a substantially identical manner to coated regions 26a through 26f on glove 10. Glove 110 further comprises a plurality of coated regions 128a through 128f located on the back of glove 110 in a substantially identical manner to the coated regions 28 through 28f provided on the back of glove 10.

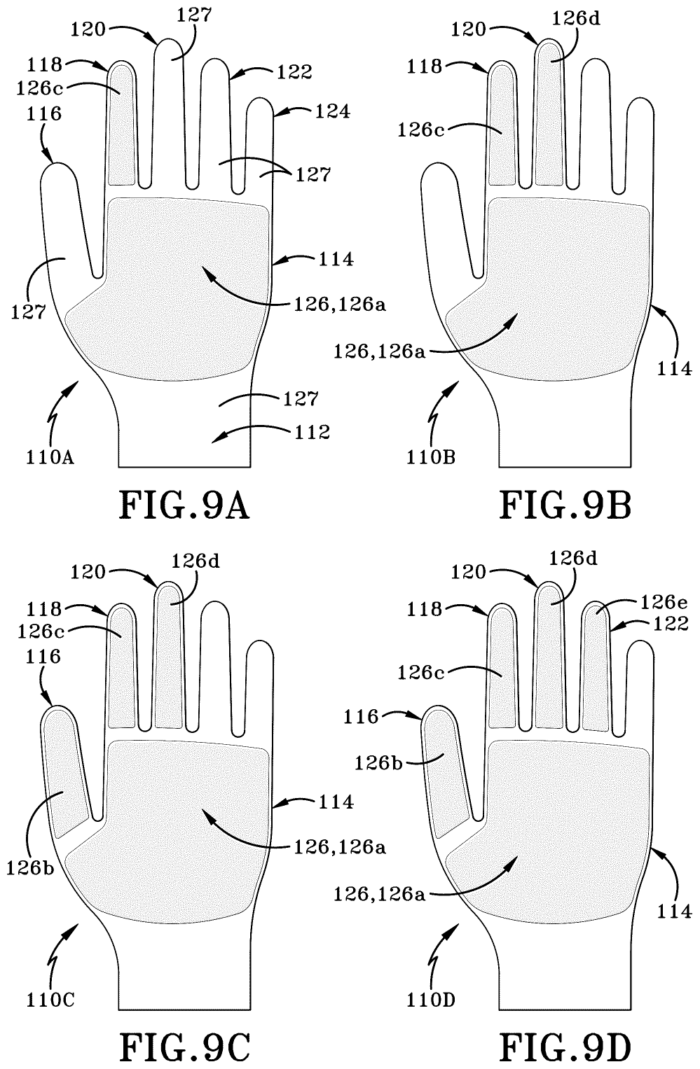

FIGS. 9A through 9D show alternative examples of the first embodiment glove 110, generally indicated as gloves 110A through 110D. FIGS. 9A through 9D show only the front of the alternative examples of the gloves 110A through 110D. The back of gloves 110A through 110D is not illustrated in the attached figures but should be understood to be substantially identical in configuration, structure, and placement of the various coated regions to the front thereof.

FIG. 9A shows a second example of the second embodiment glove, generally indicated at 110A. Glove 110A includes a first coated region 126a on palm region 114 and a third coated region 126c on index finger region 118. It will be understood that while glove 110A shows a coated region on the palm region 114 and on the index finger region 118, in other embodiments any one of the other digit regions may be provided with a coated region thereon.

Glove 110B (FIG. 9B) shows a third example of the second embodiment glove and includes first coated region 126a on palm region 114, a third coated region 126c on index finger region 118, and a fourth coated region 126d on middle finger region 120. It will be understood that while glove 110B shows a coated region on the palm region 114 and on the index finger region 118 and the middle finger region 120, in other embodiments any other two of the digit regions may be provided with coated regions thereon.

FIG. 9C shows a fourth example of the second embodiment glove, generally indicated at 110C. Glove 110C includes a first coated region 126a on palm region 114, a second coated region 126b on thumb region 116, a third coated region 126c on index finger region 118, and a fourth coated region on middle finger region 120. It will be understood that while glove 110C shows a coated region on the palm region 114 and on the thumb region 116, the index finger region 118, and the middle finger region 120, in other embodiments any other three of the digit regions may be provided with coated regions thereon.

Glove 110D (FIG. 9D) includes a first coated region 126a on palm region 114, a second coated region 126b on thumb region 116, a third coated region 126c on index finger region 118, a fourth coated region 126d on middle finger region 120, and a fifth coated region 126e on ring finger region 122. It will be understood that while glove 110D shows a coated region on the palm region 114 and on the thumb region 116, the index finger region 118, the middle finger region 120, and the ring finger region 122, in other embodiments any other four of the digit regions may be provided with coated regions thereon.

The uncoated regions of the gloves 110A through 110D are indicated in FIGS. 9A through 9D by the reference number 127. The backs of gloves 110A through 110D are substantially identical to the fronts thereof. Gloves 110A through 110D are substantially identical in all other aspects of construction and function to glove 10.

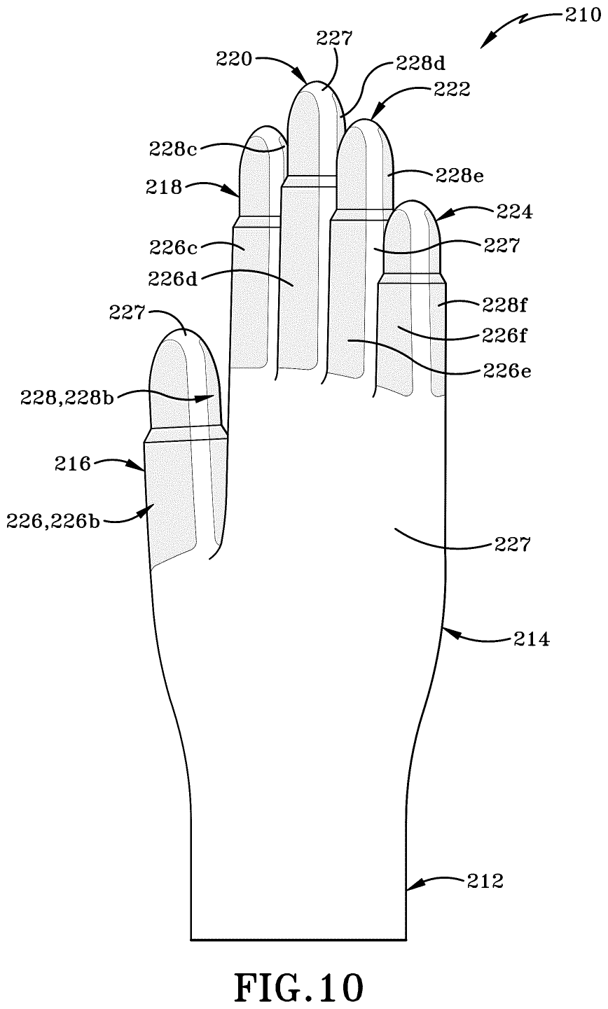

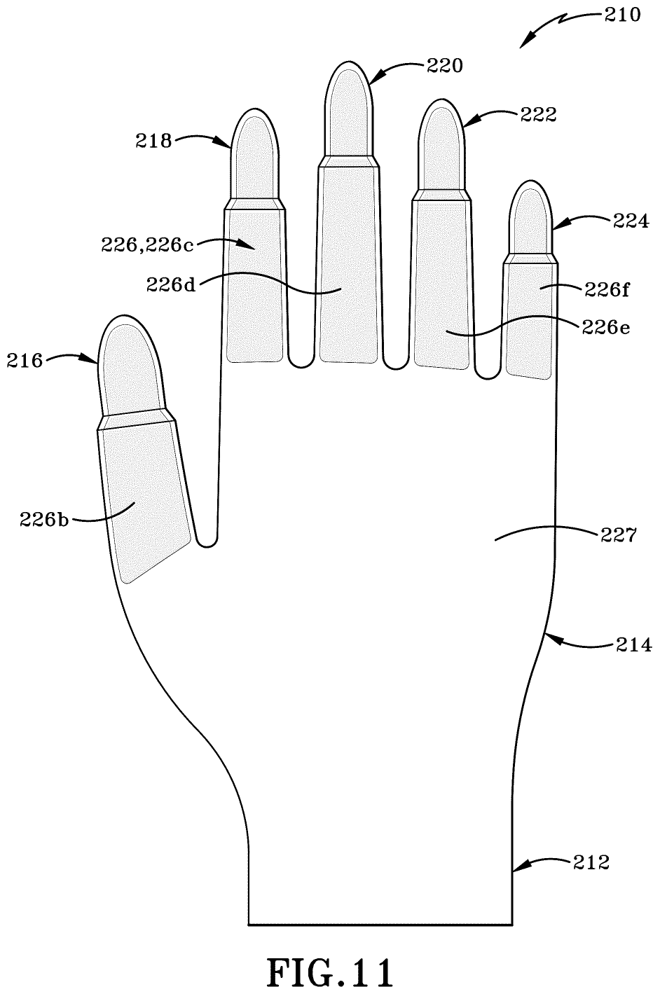

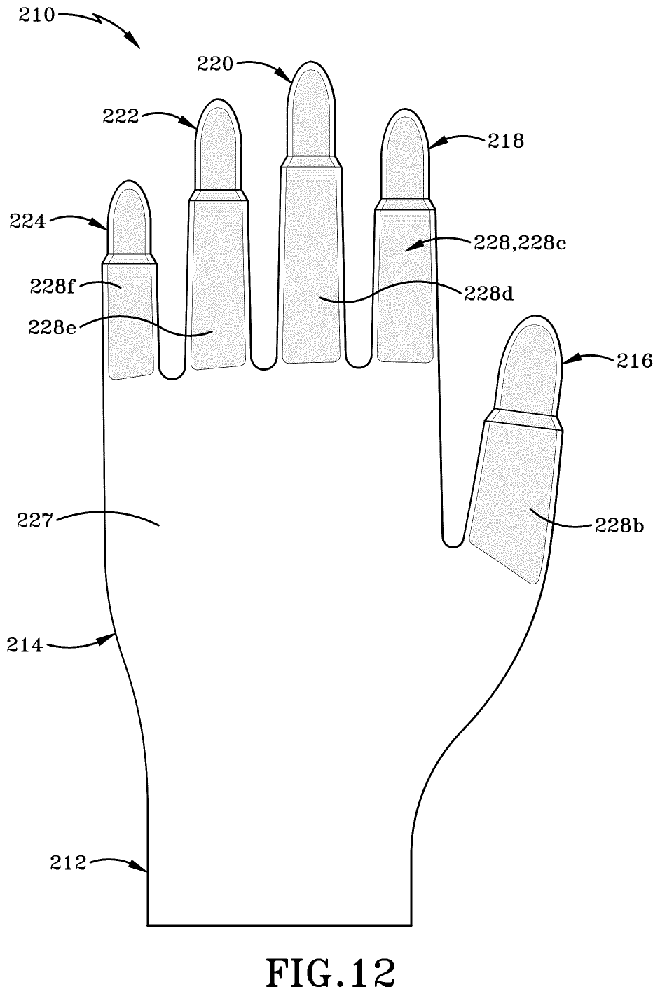

Referring now to FIGS. 10 to 13D there is shown a third embodiment of a glove in accordance with the present disclosure, generally indicated by the reference number 210. Glove 210 is substantially identical in structure and function to glove 10 except for the differences discussed hereafter. Glove 210 comprises a wrist region 212, a palm region 214, a thumb region 216, an index finger region 218, a middle finger region 220, a ring finger region 222, and a little finger region 224. Glove 210 defines an interior cavity (not numbered) which is configured to receive a hand of a person therein. The palm region 214 includes a front which will be located adjacent those regions of a person's palm which will contact an object when gripped in the person's hand.

Glove 210, like glove 10, is an ambidextrous glove which is capable of being worn on either of a left hand or a right hand of the person. Each of the digit regions 216 through 224 of glove 210 has a fingertip region, a transition region and a remaining portion defined therein which are identical to the fingertip region, transition region and remaining portion of the digit regions 16 through 24 of glove 10.

Referring still to FIGS. 10-13D, glove 210 includes a plurality of coated regions which are capable of detecting and indicating the presence of dangerous drugs and chemicals to the person wearing the glove 210. In particular, coated regions, generally indicated by the reference number 226, are provided on the front of the glove 210 and substantially identical coated regions 228 are provided on the back of the glove. Unlike glove 10, glove 210 does not include a coated region on palm region 214 such as the first coated region 26a of glove 10. Like glove 10, glove 210 does include, on the front surface of thumb region 216, a second coated region 226b. The front surface of index finger region 218 includes a third coated region 226c, the front surface of middle finger region 220 includes a fourth coated region 226d; the front surface of ring finger region 222 includes a fifth coated region 226e, and the front surface of little finger region 224 includes a sixth coated region 226f. Each of the coated regions 226b through 226f is formed and located on the front of glove 210 in a substantially identical manner to coated regions 26a through 26f on glove 10. Glove 210 further comprises a plurality of coated regions 128b, 128c, 128d, 128e, and 128f located on the back of glove 210 in a substantially identical manner to the coated regions 28b through 28f provided on the back of glove 10. The back of the glove 210, like the front thereof, lacks a coated region on the palm region 214.

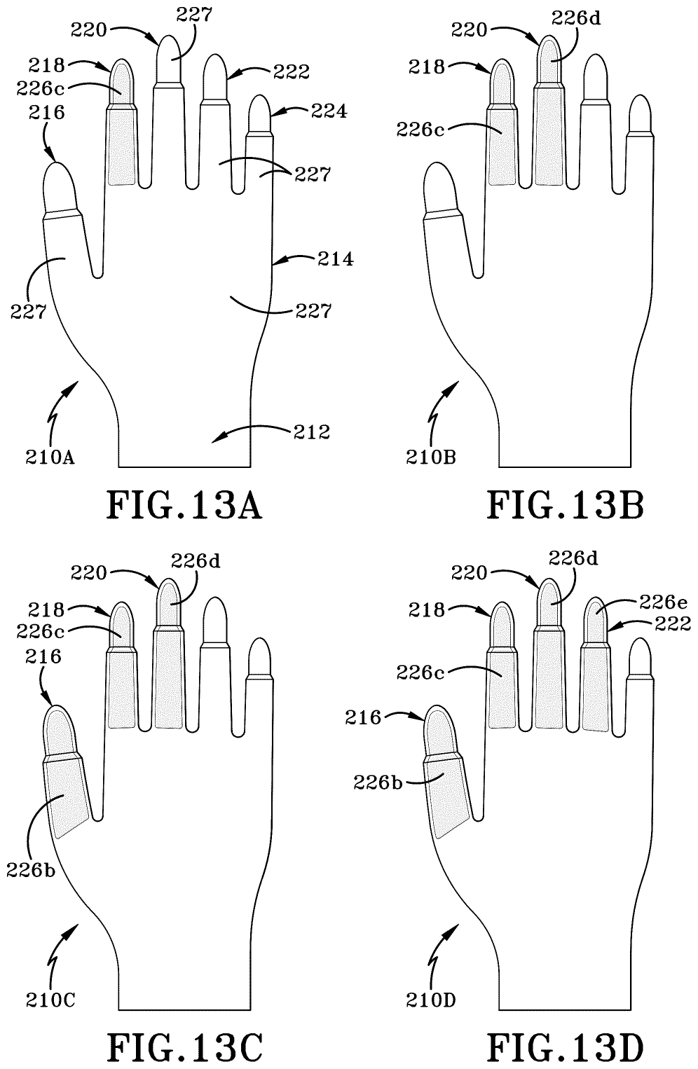

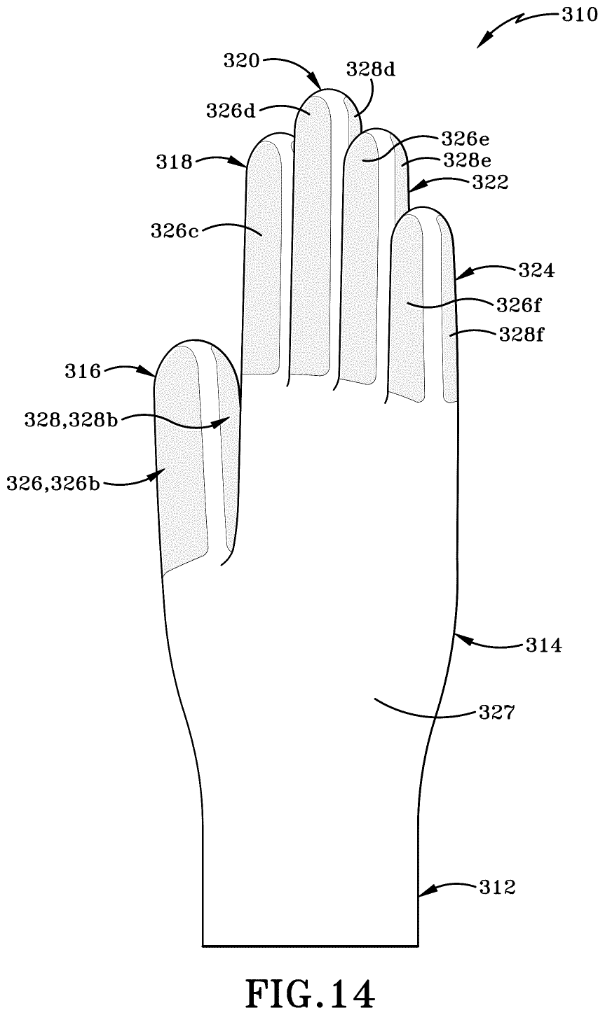

FIGS. 13A through 13D show alternative examples of the first embodiment glove 210, generally indicated as gloves 210A through 210D. FIGS. 13A through 13D show only the front of the alternative examples of the gloves 210A through 210D. The back of gloves 210A through 210D is not illustrated in the attached figures but should be understood to be substantially identical in configuration, structure, and placement of the various coated regions to the front thereof.

FIG. 13A shows a second example of the third embodiment glove, generally indicated at 210A. Glove 210A includes a third coated region 226c on index finger region 218. It will be understood that while glove 210A shows a coated region on the index finger region 218, in other embodiments any other one of the digit regions 216 through 224 may be provided with a coated region thereon.

Glove 210B (FIG. 13B) shows a third example of the third embodiment glove and includes a third coated region 226c on index finger region 218, and a fourth coated region 226d on middle finger region 220. It will be understood that while glove 210B shows a coated region on the index finger region 218 and the middle finger region 220, in other embodiments any other two of the digit regions may be provided with coated regions thereon.

FIG. 13C shows a fourth example of the third embodiment glove, generally indicated at 210C. Glove 210C includes a second coated region 226b on thumb region 216, a third coated region 226c on index finger region 218, and a fourth coated region on middle finger region 220. It will be understood that while glove 210C shows a coated region on the thumb region 216, the index finger region 218 and the middle finger region 220, in other embodiments any other three of the digit regions may be provided with coated regions thereon.

Glove 210D (FIG. 13D) includes a second coated region 226b on thumb region 216, a third coated region 226c on index finger region 218, a fourth coated region 226d on middle finger region 220, and a fifth coated region 226e on ring finger region 222. It will be understood that while glove 210D shows a coated region on the thumb region 216, the index finger region 218, the middle finger region 220, and the ring finger region 222, in other embodiments any other four of the digit regions may be provided with coated regions thereon.

The rest of the exterior surface of the front and back of the gloves 210A through 210D is free of any coating layer. The uncoated exterior surface of the gloves 210A through 210D is indicated by the reference number 227 in FIGS. 13A through 13D. It should also be noted that the backs of gloves 210A through 210D are substantially identical to the fronts thereof. Gloves 210A through 210D are substantially identical in all other aspects of construction and function to glove 10.

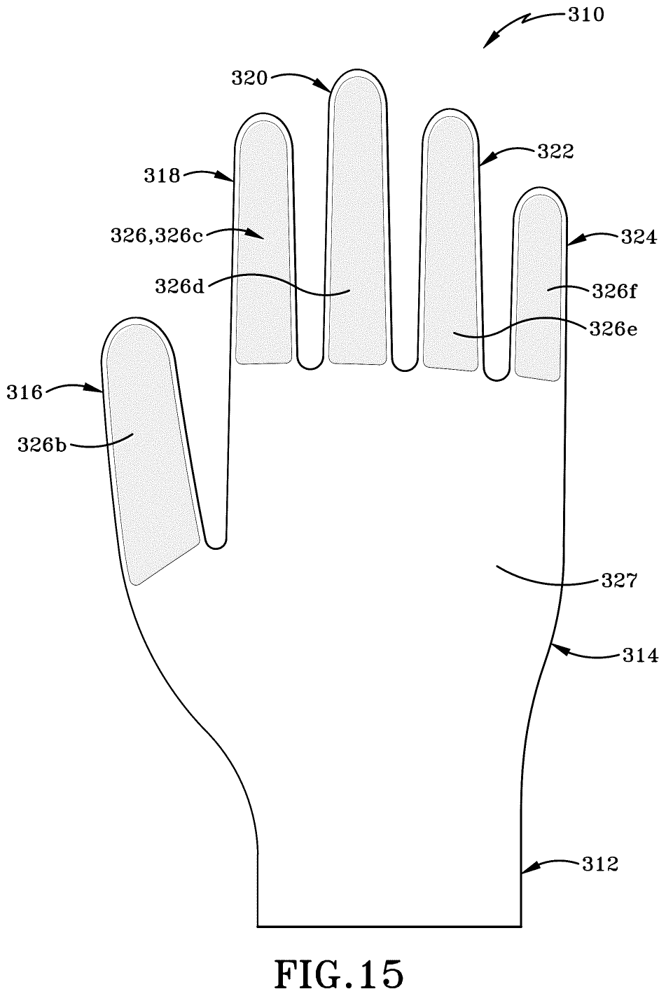

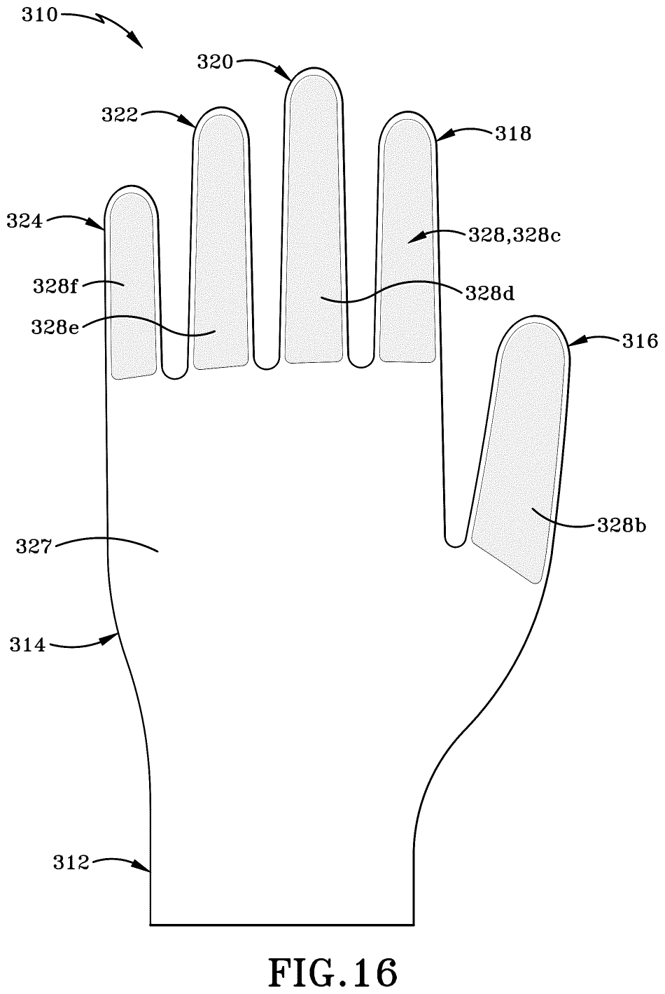

Referring now to FIGS. 15 to 17D there is shown a fourth embodiment of a glove in accordance with the present disclosure, generally indicated by the reference number 310. Glove 310 is substantially identical in structure and function to glove 110 except for the differences discussed hereafter. Glove 310 comprises a wrist region 312, a palm region 314, a thumb region 316, an index finger region 318, a middle finger region 320, a ring finger region 322, and a little finger region 324. Glove 310 defines an interior cavity (not numbered) which is configured to receive a hand of a person therein.

Glove 310 is an ambidextrous glove which, like glove 110, does not have a fingertip region, a transition region and a remaining portion provided on each of the digit regions 316 through 324. Like glove 110, glove 310 has digit regions 316 through 324 which are of substantially constant circumference from proximate the palm region 314 to proximate a tip of the associated digit region 316 through 324.

Referring still to FIGS. 15 to 17D, glove 310 includes a plurality of coated regions on the digit regions 316 through 324 which are capable of detecting and indicating the presence of dangerous drugs and chemicals to the person wearing the glove 310. In particular, coated regions, generally indicated by the reference number 326, are provided on the front of the glove 310 and on the back thereof. Unlike glove 110, glove 310 does not include a coated region on the palm region 314.

Glove 310 includes, on the front surface of thumb region 316, a second coated region 326b. The front surface of index finger region 318 includes a third coated region 326c, the front surface of middle finger region 320 includes a fourth coated region 1126d; the front surface of ring finger region 1122 includes a fifth coated region 326e, and the front surface of little finger region 324 includes a sixth coated region 326f. Glove 310 also includes coated regions 328b, 328c, 328d, 328e, and 328f on the back of the glove in substantially the same locations as the regions 326b, 326c, 326d, and 326f on the front of glove 310.

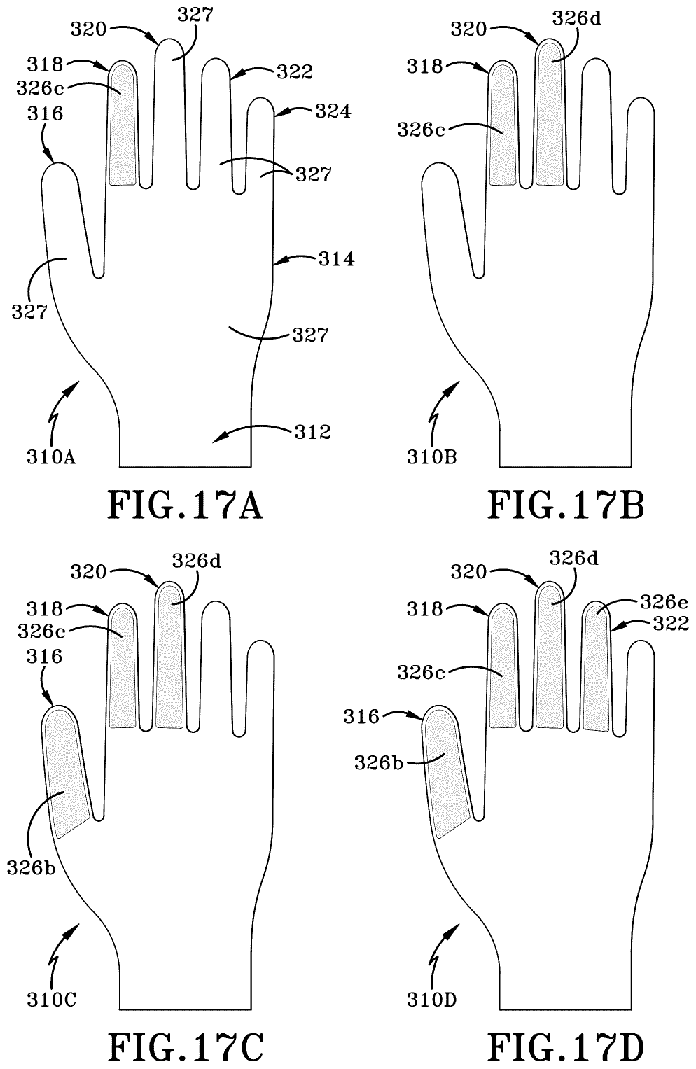

FIGS. 17A through 17D show alternative examples of the fourth embodiment glove 130, generally indicated as gloves 310A through 310D. FIGS. 17A through 17D show only the fronts of the alternative examples of the gloves 310A through 310D. The back of gloves 310A through 310D are not illustrated in the attached figures but should be understood to be substantially identical to the fronts thereof.

FIG. 17A shows a second example of the fourth embodiment glove, generally indicated at 310A. Glove 310A includes a third coated region 326c on index finger region 318. It will be understood that while glove 310A shows a coated region on the index finger region 318, in other embodiments any other one of the digit regions may be provided with a coated region thereon.

Glove 310B (FIG. 17B) shows a third example of the fourth embodiment glove and includes a third coated region 326c on index finger region 318, and a fourth coated region 326d on middle finger region 320. It will be understood that while glove 310B shows a coated region on the index finger region 318 and the middle finger region 320, in other embodiments any other two of the digit regions may be provided with coated regions thereon.

FIG. 17C shows a fourth example of the fourth embodiment glove, generally indicated at 310C. Glove 310C includes a second coated region 326b on thumb region 316, a third coated region 326c on index finger region 318, and a fourth coated region on middle finger region 320. It will be understood that while glove 310C shows a coated region on the thumb region 316, the index finger region 318, and the middle finger region 320, in other embodiments any other three of the digit regions may be provided with coated regions thereon.

Glove 310D (FIG. 17D) includes a second coated region 326b on thumb region 316, a third coated region 326c on index finger region 318, a fourth coated region 326d on middle finger region 320, and a fifth coated region 326e on ring finger region 322. The rest of the exterior surface of the front of glove 310D is free of any coating layer. It will be understood that while glove 310D shows a coated region on the thumb region 316, the index finger region 318, the middle finger region 320, and the ring finger region 322, in other embodiments any other four of the digit regions may be provided with coated regions thereon.

The backs of gloves 310A through 310D are substantially identical to the fronts thereof. The rest of the exterior surface of the front and back of gloves 310A through 310D is free of any drug-detecting and drug-indicating coating, as is indicated by the reference number 327 in FIGS. 17A through 17D. Gloves 310A through 310D are substantially identical in all other aspects of construction and function as glove 10.

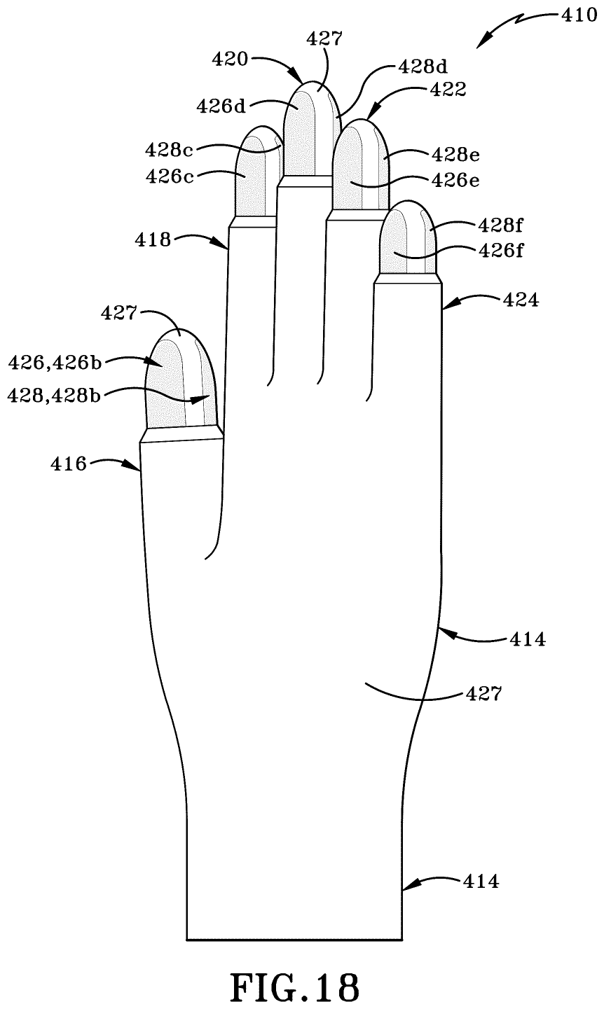

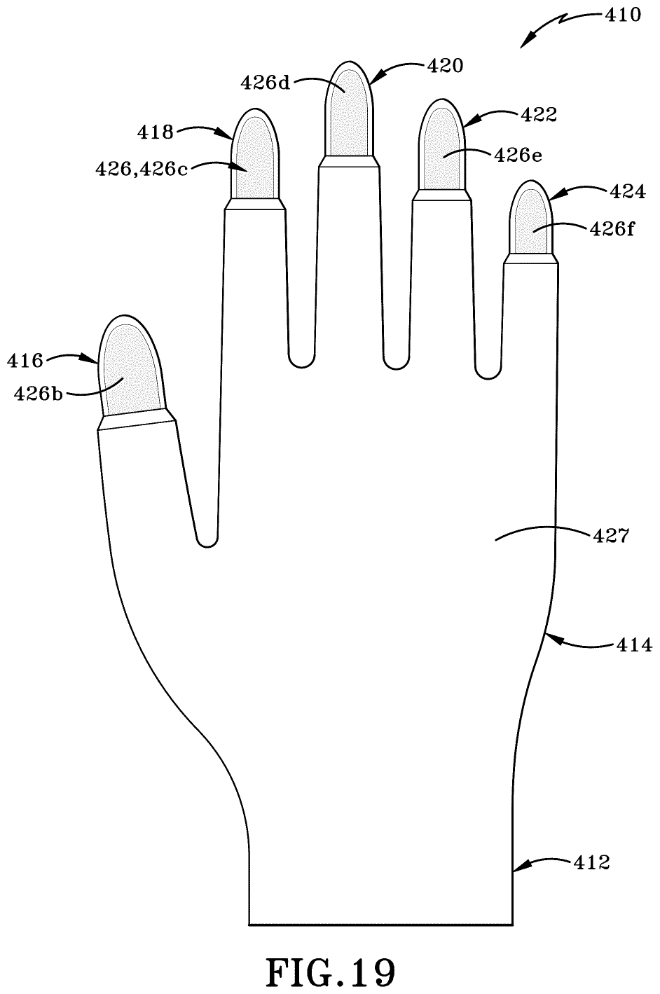

Referring now to FIGS. 18 through 21D, there is shown a fifth embodiment of a glove in accordance with the present disclosure, generally indicated at 410. Glove 410 comprises a wrist region 412, a palm region 414, a thumb region 416, an index finger region 418, a middle finger region 420, a ring finger region 422, and a little finger region 424. Glove 410 defines an interior cavity (not numbered) which is configured to receive a hand of a person therein.

Glove 410, like glove 10, is an ambidextrous glove which is capable of being worn on either of a left hand or a right hand of the person. Each of the digit regions 416 through 424 of glove 410 has a fingertip region, a transition region and a remaining portion defined therein which are identical to the fingertip region, transition region and remaining portion of the digit regions 16 through 24 of glove 10.

Referring still to FIGS. 18 to 21D, glove 410 includes a plurality of coated regions which are capable of detecting and indicating the presence of dangerous drugs and chemicals to the person wearing the glove 410. Glove 410 differs from glove 10 in that only the fingertip regions of each of the digit regions 416 through 424 is provided with coated regions. Like glove 10, glove 410 does include, on the front surface of the fingertip region of the thumb region 416, a second coated region 426b. The front surface of the fingertip region of the index finger region 418 includes a third coated region 426c, the front surface of the fingertip region of the middle finger region 420 includes a fourth coated region 426d; the front surface of the fingertip region of the ring finger region 422 includes a fifth coated region 426e, and the front surface of the fingertip region of the little finger region 424 includes a sixth coated region 426f. Each of the coated regions 426b through 426f is formed and located on the front of the fingertip regions of glove 410 in a substantially identical manner to the coated regions 26b through 26f on glove 10.

Glove 410 further comprises a plurality of coated regions 428b, 428c, 428d, 428e, and 428f located only on the back of the fingertip regions of the digit regions 416 through 424 of glove 410. The coated regions 482b through 428f on the back of glove 410 are located in a substantially identical manner to the coated regions 426b through 426f provided on the front of glove 410.

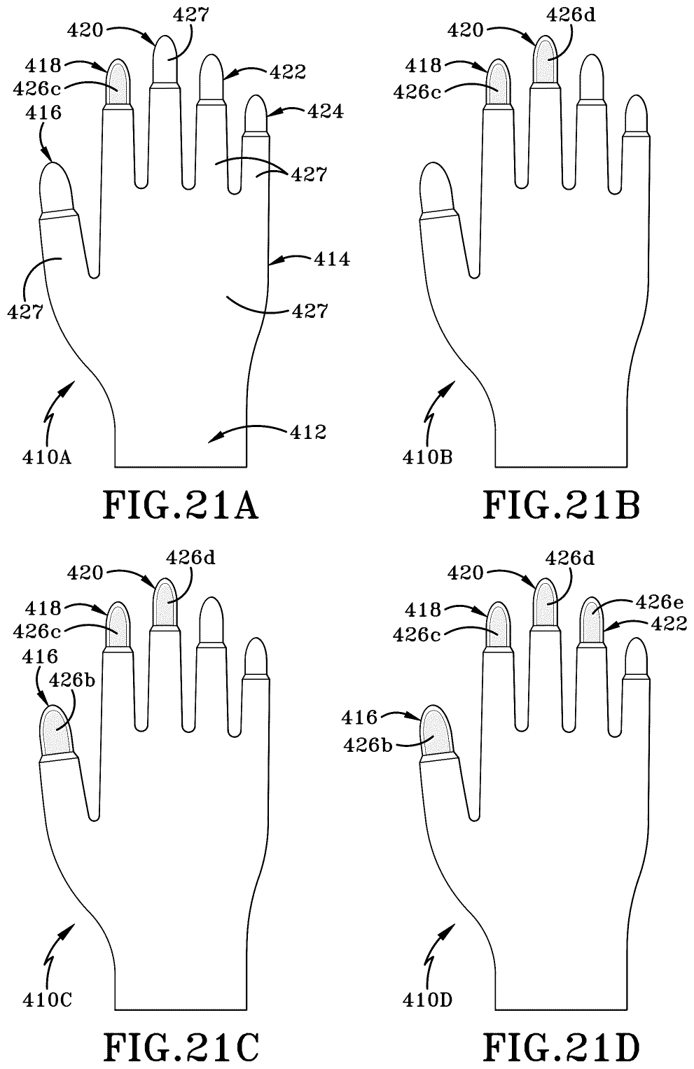

FIGS. 21A through 21D show alternative examples of the fifth embodiment glove 410, generally indicated as gloves 410A through 410D. FIGS. 21A through 21D show only the front of the alternative examples of the gloves 410A through 410D. The backs of gloves 410A through 410D are not illustrated in the attached figures but they should be understood to be substantially identical in configuration, structure, and placement of the various coated regions provided on the fronts thereof.

FIG. 21A shows a second example of the fifth embodiment glove, generally indicated at 410A. Glove 410A includes a third coated region 426c on the fingertip region of index finger region 418. It will be understood that while glove 410A shows a coated region on the fingertip region of the index finger region 418, in other embodiments any other one of the fingertip regions of the digit regions may be provided with a coated region on the fingertip region thereof.

Glove 410B (FIG. 21B) shows a third example of the fifth embodiment glove and includes a third coated region 426c on the fingertip region of index finger region 418, and a fourth coated region 426d on the fingertip region of finger region 420. It will be understood that while glove 410B shows a coated region on the fingertip region of the index finger region 418 and the middle finger region 420, in other embodiments any other two of the digit regions may be provided with coated regions on the fingertip regions thereof.

FIG. 21C shows a fourth example of the fifth embodiment glove, generally indicated at 410C. Glove 410C includes a second coated region 426b on the fingertip region of thumb region 416, a third coated region 426c on the fingertip region of index finger region 418, and a fourth coated region on the fingertip region of middle finger region 420. It will be understood that while glove 410C shows a coated region on the thumb region 416, the index finger region 418, and the middle finger region 420, in other embodiments any other three of the digit regions may be provided with coated regions on the fingertip regions thereof.

Glove 410D (FIG. 21D) includes a second coated region 426b on the fingertip region of thumb region 416, a third coated region 426c on the fingertip region of index finger region 418, a fourth coated region 426d on the fingertip region of middle finger region 420, and a fifth coated region 426e on the fingertip region of ring finger region 422. It will be understood that while glove 410D shows a coated region on the thumb region 416, the index finger region 418, the middle finger region 420, and the ring finger region 422, in other embodiments any other four of the digit regions may be provided with coated regions on the fingertip regions thereof.

The rest of the exterior surface of the fronts of gloves 410A through 410D are free of any coating layer. This is indicated by the reference number 427 in FIGS. 21A through 21D. The backs of glove 410A through 410D are substantially identical to the fronts thereof. Gloves 410A through 410D are substantially identical in all other aspects of construction and function to glove 10.

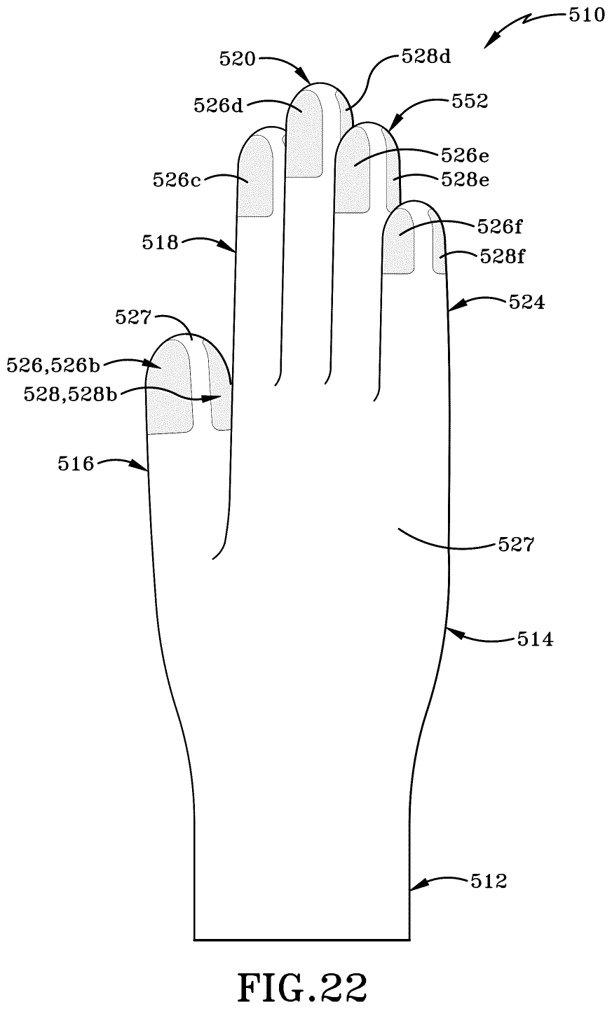

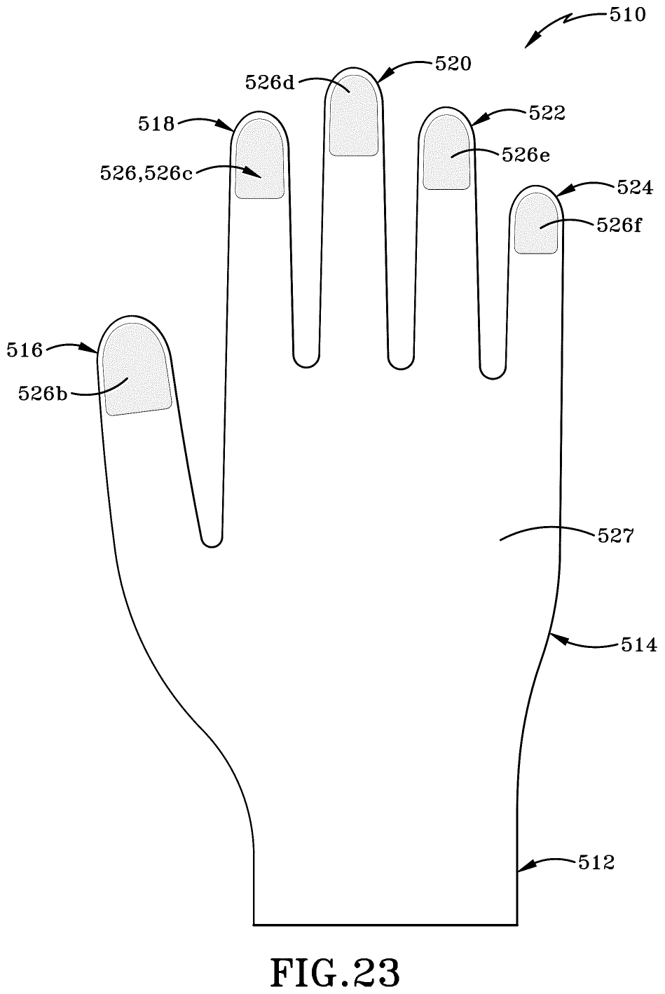

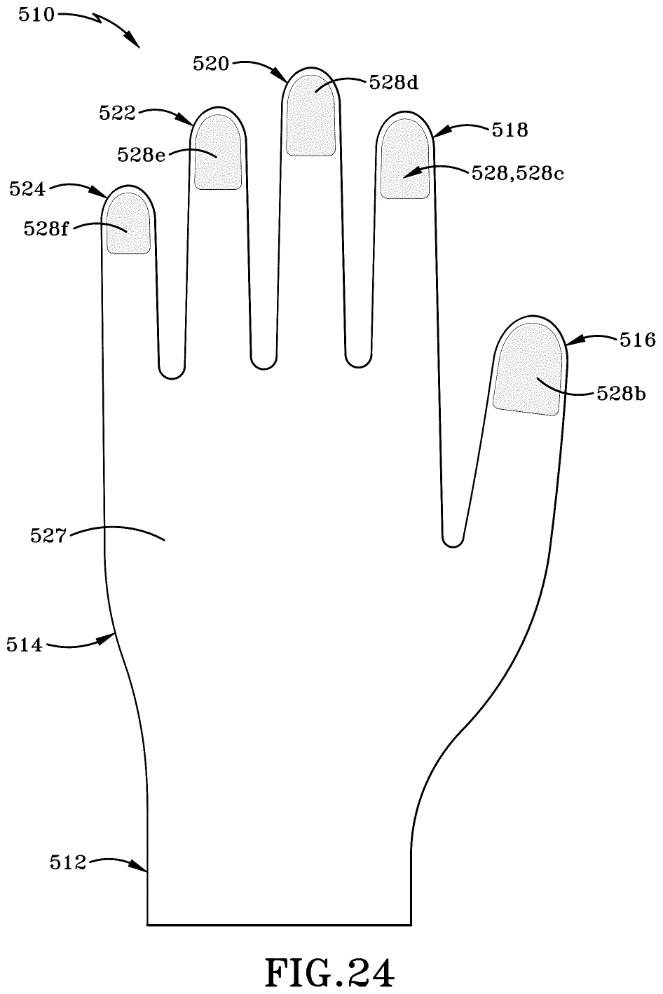

Referring now to FIGS. 22 to 25D there is shown a sixth embodiment of a glove in accordance with the present disclosure, generally indicated by the reference number 510. Glove 510 is substantially identical in structure and function to glove 410 except for the differences discussed hereafter. Glove 510 comprises a wrist region 512, a palm region 514, a thumb region 516, an index finger region 518, a middle finger region 520, a ring finger region 522, and a little finger region 524. Glove 510 defines an interior cavity (not numbered) which is configured to receive a hand of a person therein. The palm region 514 includes a front which will be located adjacent those regions of a person's palm which will contact an object when the object is gripped in the person's hand.

Glove 510, like glove 10, is an ambidextrous glove which is capable of being worn on either of a left hand or a right hand of the person. While glove 410 includes narrower circumference fingertip regions and flaring transition regions on the digit regions 416 through 424, glove 510 is differently configured relative to glove 410 in that the digit regions 516 through 524 of glove 510 are of substantially constant diameter along their lengths.

Referring still to FIGS. 18-25D, glove 510 includes a plurality of coated regions which are capable of detecting and indicating the presence of dangerous drugs and chemicals to the person wearing the glove 510. In particular, coated regions, generally indicated by the reference number 526, are provided on the front of the glove 510 and on the back of the glove. In glove 510, an upper portion of each digit region 516 to 524 includes a coated region. The upper portion originates at a tip of the associated digit region and extends downwardly toward the palm region 514. The upper portion and the coated region on that upper portion terminates proximate where a person's first knuckle will be located when glove 510 is worn. Glove 510 does not include any other coated regions thereon.

On glove 510 the front of the thumb region 516 includes a second coated region 526b on the upper portion thereof, the index finger region 518 includes a third coated region 526c on an upper portion thereof, the middle finger region 520 includes a fourth coated region 526d on an upper portion thereof, the ring finger region 526d includes a fifth coated region 526e on an upper portion thereof, and the little finger region 524 includes a sixth coated region 526f on an upper portion thereof.

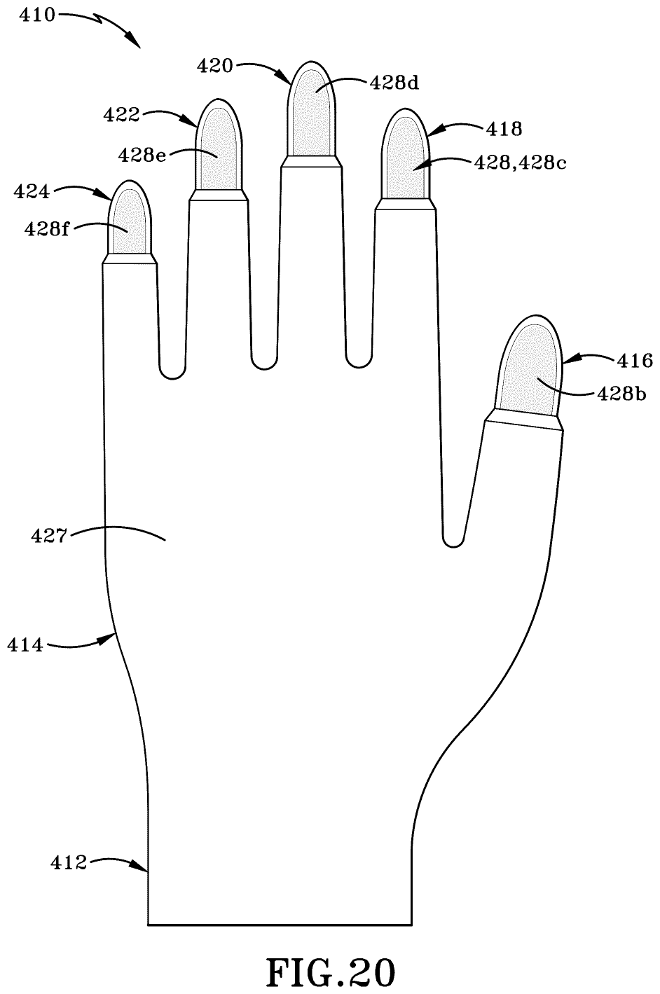

Similarly, as seen in FIG. 20, the back of the fingertip regions 516 through 524 include a second coated region 528b, a third coated region 528c, a fourth coated region 528d, a fifth coated region 528e and a sixth coated region 528f on an upper portion thereof, respectively. The rest of the front of the glove 510 and the rest of the back of the glove are free of any coated regions. The uncoated rest of the glove is indicated by reference number 527.

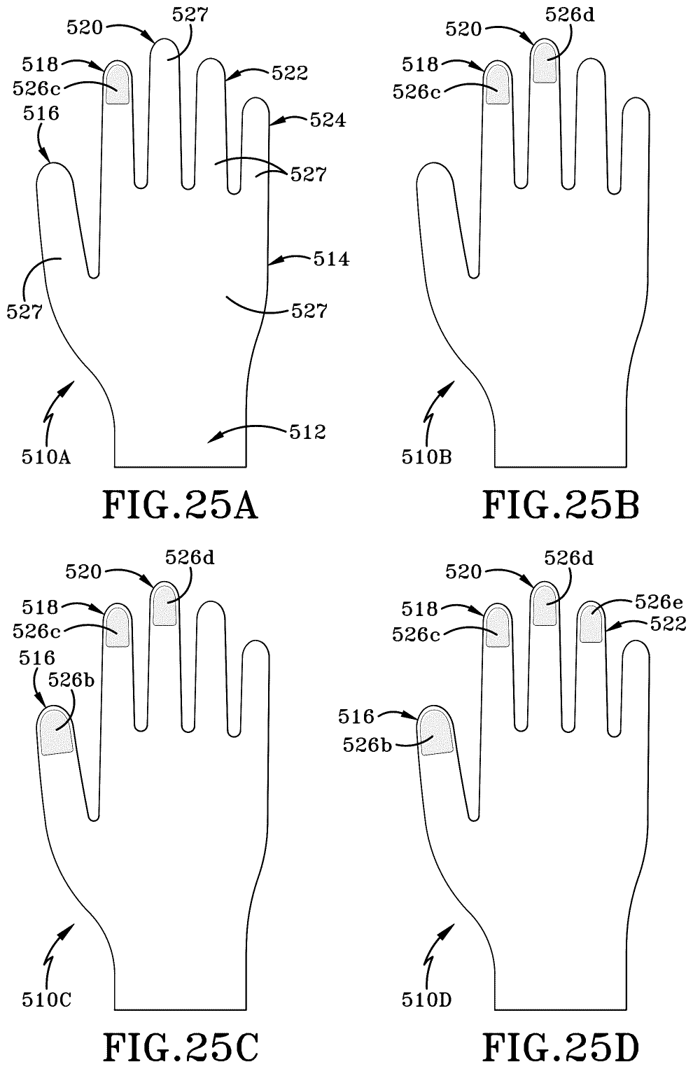

FIGS. 25A through 25D show alternative examples of the sixth embodiment glove 510, generally indicated as gloves 510A through 510D. FIGS. 25A through 25D show only the front of the alternative examples of the gloves 510A through 510D. The backs of gloves 510A through 510D are not illustrated in the attached figures but they should be understood to be substantially identical in configuration, structure, and placement of the various coated regions to the fronts thereof.

FIG. 25A shows a second example of the sixth embodiment glove, generally indicated at 510A. Glove 510A includes a third coated region 526c on the upper portion of index finger region 518. It will be understood that while glove 510A shows a coated region on the upper portion of the index finger region 518, in other embodiments any one other of the digit regions may be provided with a coated region on its upper portion.

Glove 510B (FIG. 25B) shows a third example of the sixth embodiment glove and includes a third coated region 526c on the upper portion of index finger region 518, and a fourth coated region 526d on the upper portion of finger region 520. It will be understood that while glove 510B shows a coated region on the upper portion of the index finger region 518 and the middle finger region 520, in other embodiments any other two of the digit regions may be provided with coated regions on their upper portions.

FIG. 25C shows a fourth example of the sixth embodiment glove, generally indicated at 510C. Glove 510C includes a second coated region 526b on the upper portion of thumb region 516, a third coated region 526c on the upper portion of index finger region 518, and a fourth coated region on the upper portion of middle finger region 520. It will be understood that while glove 510C shows a coated region on the thumb region 516, the index finger region 518, and the middle finger region 520, in other embodiments any other three of the digit regions may be provided with coated regions on their upper portions.

Glove 510D (FIG. 25D) includes a second coated region 526b on the upper portion of thumb region 516, a third coated region 526c on the upper portion of index finger region 518, a fourth coated region 526d on the upper portion of middle finger region 520, and a fifth coated region 526e on the upper portion of ring finger region 522. It will be understood that while glove 510D shows a coated region on the upper portions of thumb region 516, the index finger region 518, the middle finger region 520, and the ring finger region 522, in other embodiments any other four of the digit regions may be provided with coated regions on their upper portions.

The rest of the exterior surface of the fronts of gloves 510A through 510D are free of any coating layer. This is indicated by the reference number 527 in FIGS. 25A through 25D. The backs of glove 510A through 510D are substantially identical to the fronts thereof. Gloves 510A through 510D are substantially identical in all other aspects of construction and function to glove 10.

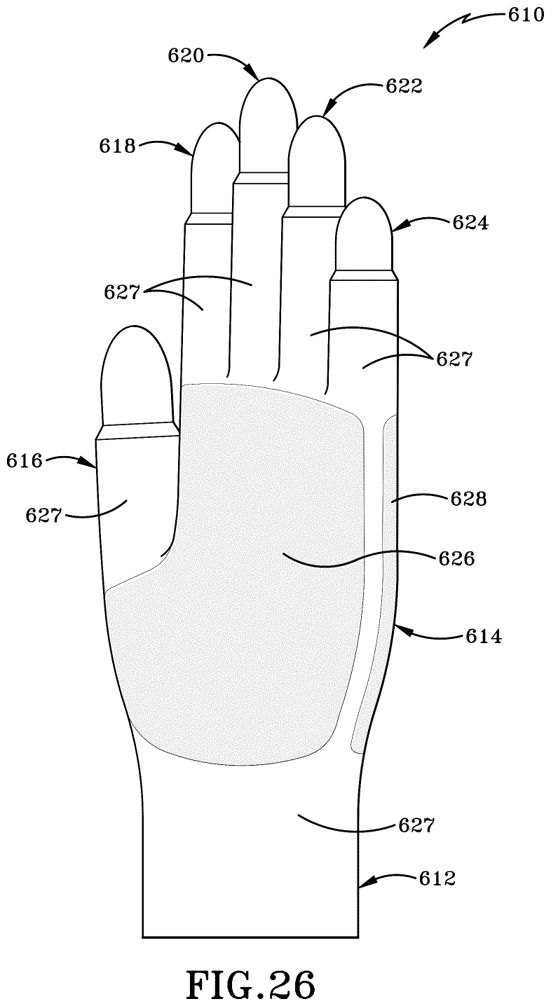

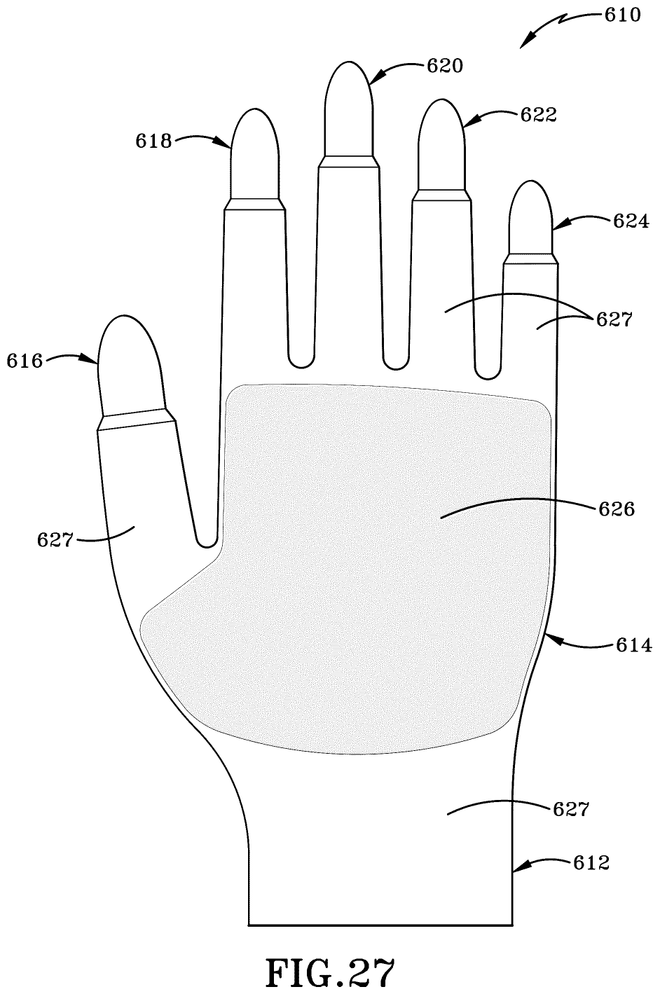

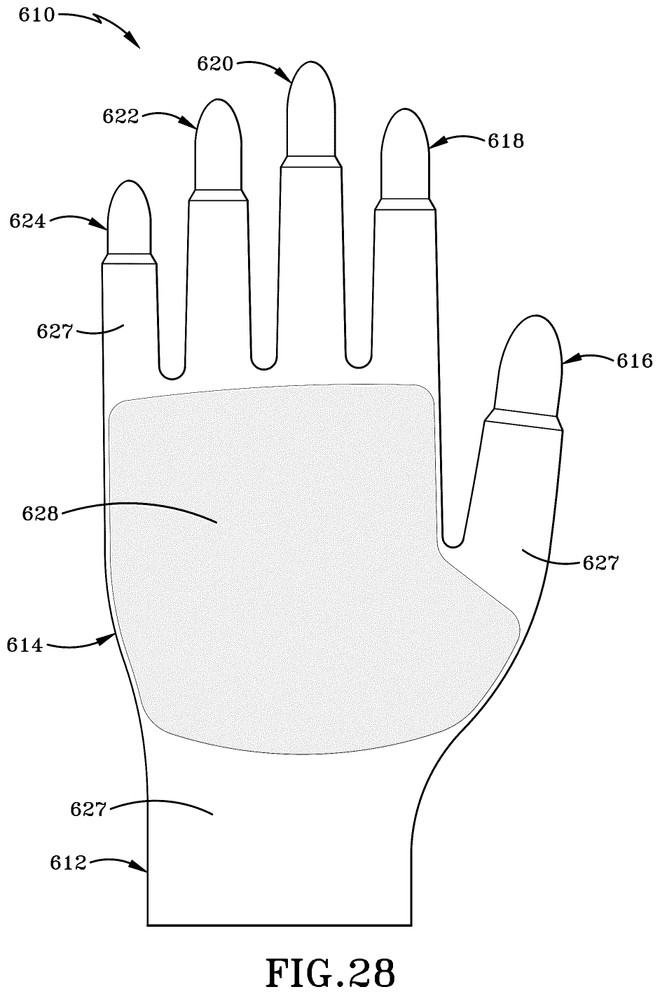

Referring now to FIGS. 26 to 28 there is shown a seventh embodiment of a glove in accordance with the present disclosure, generally indicated by the reference number 610. Glove 610 is substantially identical in structure and function to glove 10 except for the differences discussed hereafter. Glove 610 comprises a wrist region 612, a palm region 614, a thumb region 616, an index finger region 618, a middle finger region 620, a ring finger region 622, and a little finger region 624. Glove 610 defines an interior cavity (not numbered) which is configured to receive a hand of a person therein. The palm region 614 includes a front which will be located adjacent those regions of a person's palm which will contact an object when the object is gripped in the person's hand.

Glove 610, like glove 10, is an ambidextrous glove which is capable of being worn on either of a left hand or a right hand of the person. Glove 610, like glove 10, includes narrower circumference fingertip regions and flaring transition regions on the digit regions 616 through 624.

Glove 610 differs from glove 10 in that glove 610 includes a first coated region 626 on the front of palm region 614 and a first coated region 628 on the back of palm region 614 but does not include any coated regions on any of the digit regions. The rest of the front and back of the glove 610 which surrounds the coated regions 626 and 628 is free of any coating and is indicated by the reference number 627.

Glove 610 is substantially identical in all other aspects of construction and function to glove 10.

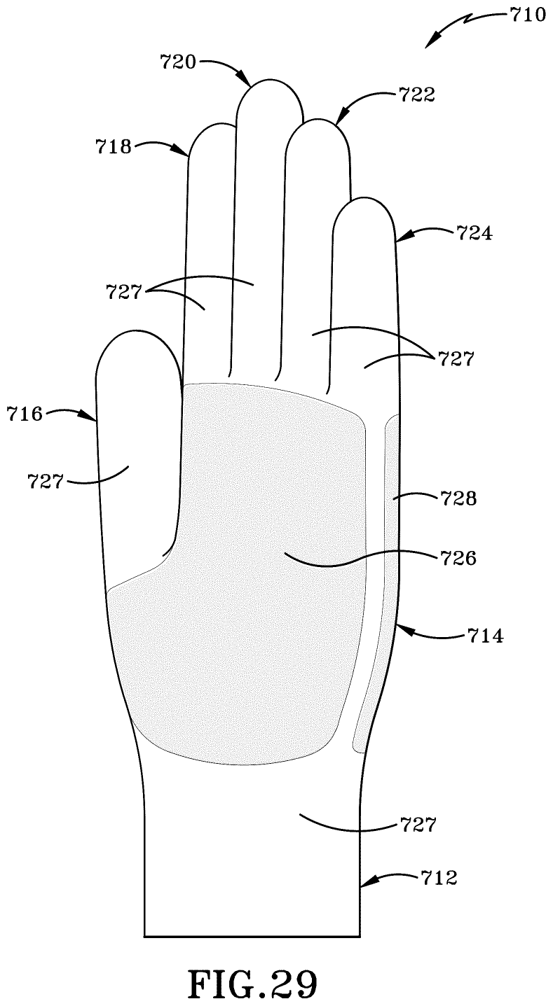

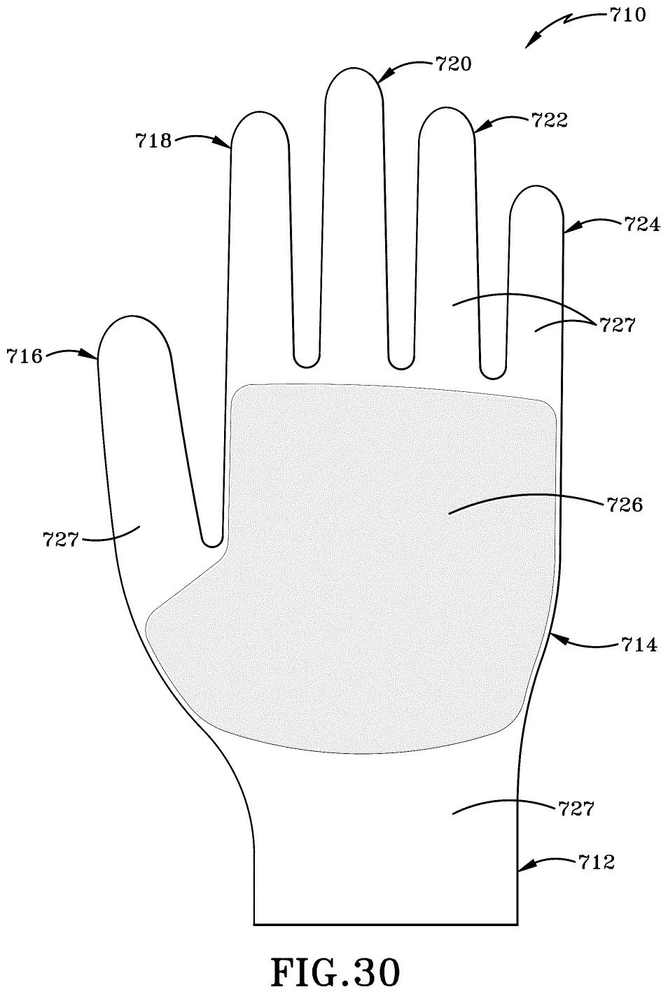

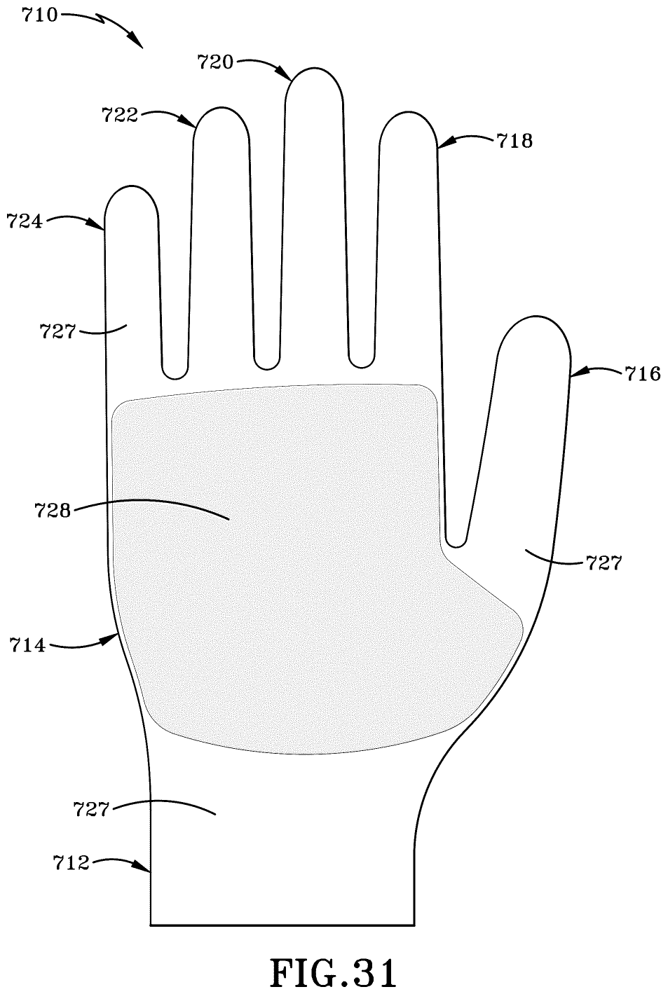

Referring now to FIGS. 29 to 31 there is shown an eighth embodiment of a glove in accordance with the present disclosure, generally indicated by the reference number 710. Glove 710 is substantially identical in structure and function to glove 610 except for the differences discussed hereafter. Glove 710 comprises a wrist region 712, a palm region 714, a thumb region 716, an index finger region 718, a middle finger region 720, a ring finger region 722, and a little finger region 724. Glove 710 defines an interior cavity (not numbered) which is configured to receive a hand of a person therein. The palm region 714 includes a front which will be located adjacent those regions of a person's palm which will contact an object when the object is gripped in the person's hand.

Glove 710, like glove 610, is an ambidextrous glove which is capable of being worn on either of a left hand or a right hand of the person. Glove 710, unlike glove 610, does not include narrower circumference fingertip regions and flaring transition regions on the digit regions 716 through 724. Instead, glove 710 has digit regions 716 through 724 which are of a substantially constant diameter along their lengths.

Glove 710, like glove 610, includes a first coated region 726 on the front of palm region 714 and a first coated region 728 on the back of palm region 714 and does not include any coated regions on any of the digit regions. The rest of the front and back of the glove 710 which surrounds the coated regions 726 and 728 is free of any coating and is indicated by the reference number 727.

Glove 710 is substantially identical in all other aspects of construction and function to glove 10.

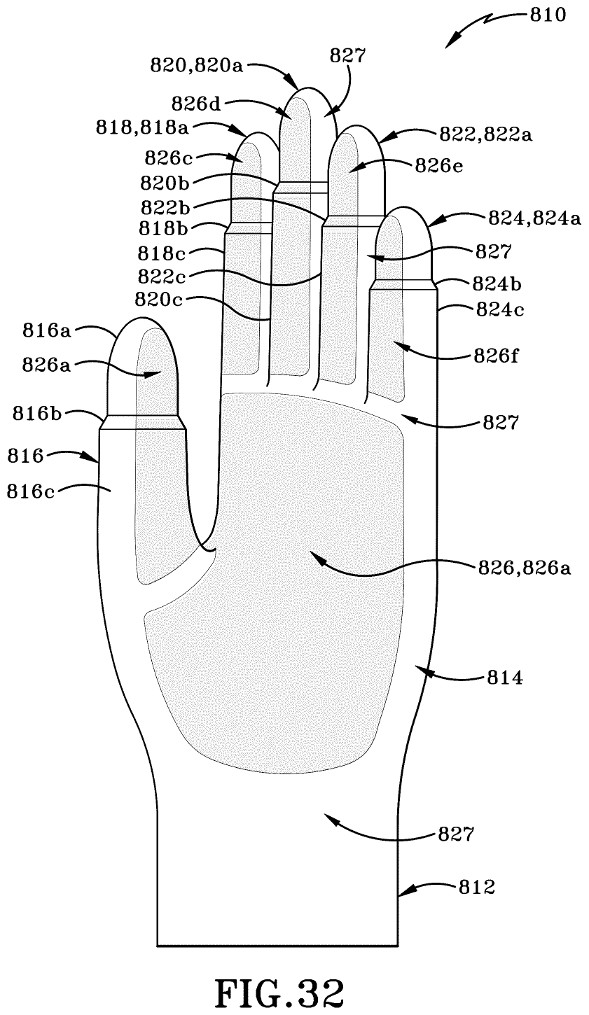

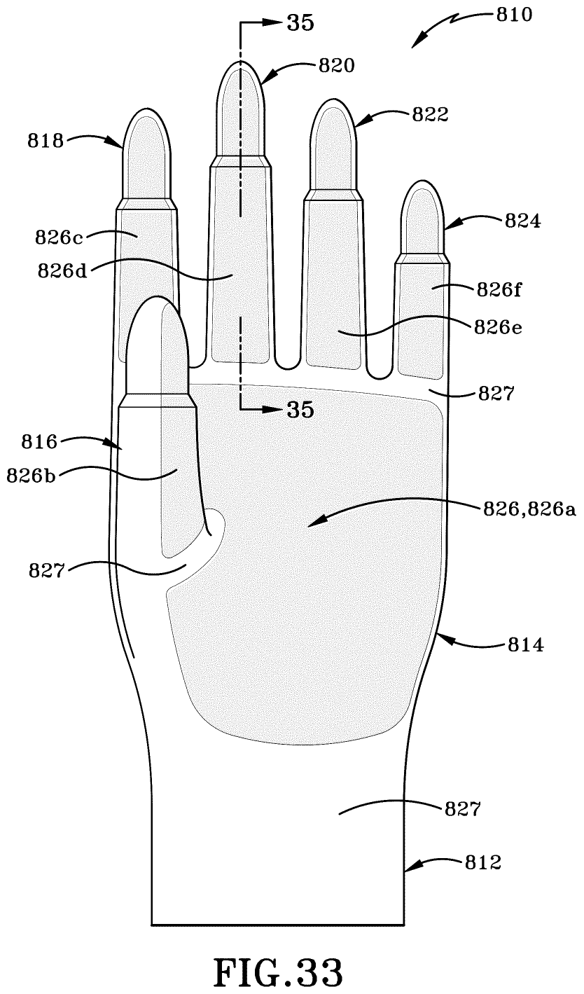

Referring now to FIGS. 32 to 36D there is shown a first example of a ninth embodiment of a glove in accordance with the present disclosure, generally indicated at 810. Glove 810 is substantially identical in structure and function to glove 10, except in the ways which will be discussed hereafter. Glove 810 comprises a wrist region 812, a palm region 814, a thumb region 816, an index finger region 818, a middle finger region 820, a ring finger region 822, and a little finger region 824. Glove 810 defines an interior cavity (not numbered) which is configured to receive a hand of a person therein.

While glove 10 is an ambidextrous glove, glove 810 is a hand-specific glove, meaning the glove 810 can only be worn on one hand instead of on either hand. In particular, glove 810 is illustrated as being a hand-specific glove which is configured to be worn on a person's left hand. A glove for a person's right hand will be configured as a mirror image of glove 810. In a hand-specific glove the thumb region is not aligned in the same plane as the index finger region 818, middle finger region 820, ring finger region 822, and little finger region 824.

As illustrated in each of FIGS. 32 to 36D, each digit region of glove 810 includes a reduced circumference fingertip region, a flaring transition region, and a remaining portion. Thumb region 816 includes a fingertip region 816a, a transition portion 816b, and a remaining portion 816c. Index finger region 818 includes a fingertip region 818a, a transition region 816b, and a remaining portion 818c. Middle finger region 820 includes fingertip region 820a, a transition region 820b, and a remaining portion 820c. Ring finger region 822 includes a fingertip region 822a, a transition region 820b, and a remaining portion 822c. Little finger region 824 includes a fingertip region 824a, a transition region 824b, and remaining portion 824c.

Glove 810, like glove 10, includes a plurality of coated regions on the palm region 814 and digit region 816 through 824. Palm region 814 includes a first coated region 826a which covers the gripping surface of palm region 814. The front surface of thumb region 816 includes a second coated region 826b, the front surface of index finger region 818 includes a third coated region 826c, the front surface of middle finger region 820 includes a fourth coated region 826d; the front surface of ring finger region 822 includes a fifth coated region 826e, and the front surface of little finger region 824 includes a sixth coated region 826f. Each of the coated regions 826b through 826f extends from proximate the palm region 814 of glove 810 to proximate a tip of the associated thumb region or finger region.

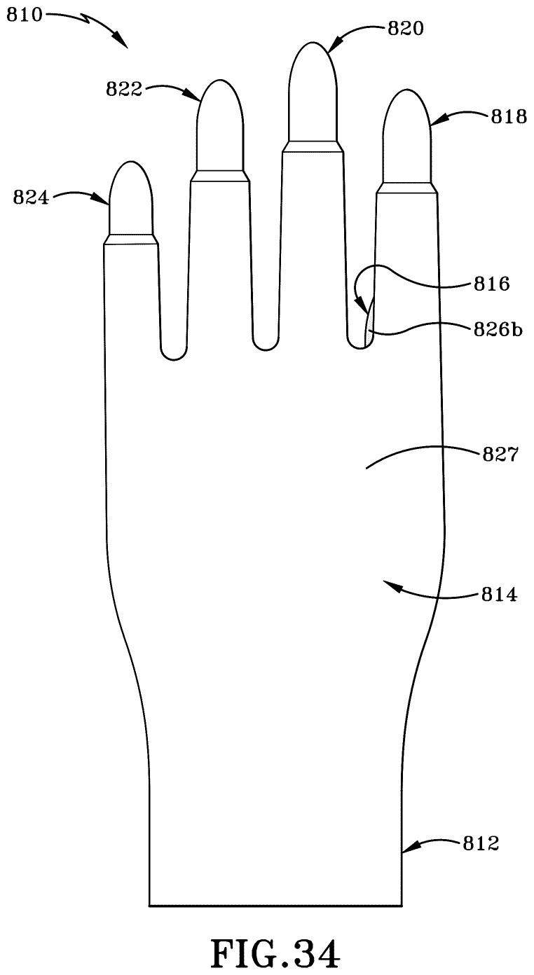

Glove 810 differs from glove 10 in that the back of the glove is free of any coating layer on the palm region 814 and digit regions 816 through 824. This is best seen in FIG. 34. The coating free exterior surface of the back of the glove is indicated by the reference number 827.

A region free of the opioid/drug detected coating is located between first coated region 826a on palm region 814 and the second coated region 826b on thumb region 816. The region which is free of the coating is indicated by the reference number 827. Similarly, a coating-free region 827 is provided between the third coated region 826c on index finger region 818 and first coated region 826a on the front of palm region 814, and between the fourth coated region 826d on middle finger region 820 and first coated region 826a; and between the fifth coated region 826e on ring finger region 822 and first coated region 826a; and between the sixth coated region 826f on little finger region 824 and first coated region 826a on the front of palm region 814. The left and right sides of each of the thumb region 816, index finger region 818, middle finger region 820, ring finger region 822, and little finger region 824 are all free of the coating layer. The coating free regions 827 are substantially continuous with one another.

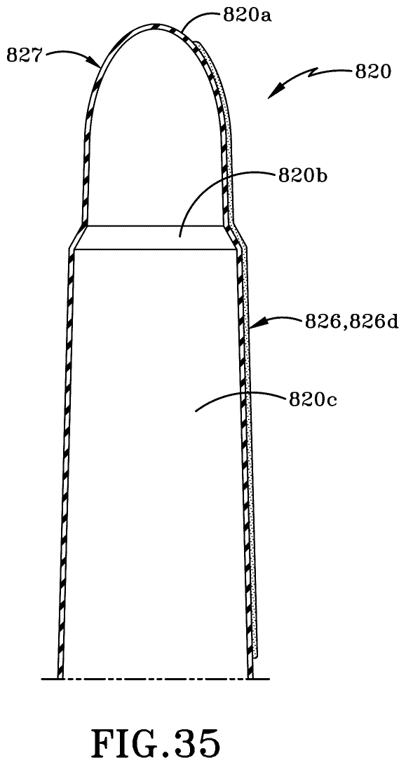

FIG. 35 shows a cross section of middle finger region 820 showing the fourth coated region 826d located on an exterior surface of the front surface of middle finger region 820. The coated region 826d is a separate layer which is applied over the exterior surface of the front surface of the middle finger region 820 and is bonded thereto. The tip of middle finger region 820 is free of coating layer and is therefore a coating free region 827. A cavity 820c is defined by an interior surface of middle finger region 820. When the glove 810 is worn, cavity 820c receives a person's middle finger therein. The coated regions 826a, 826b, 826e, and 826f are all similarly configured to the fourth coated regions 826d illustrated in FIG. 4.

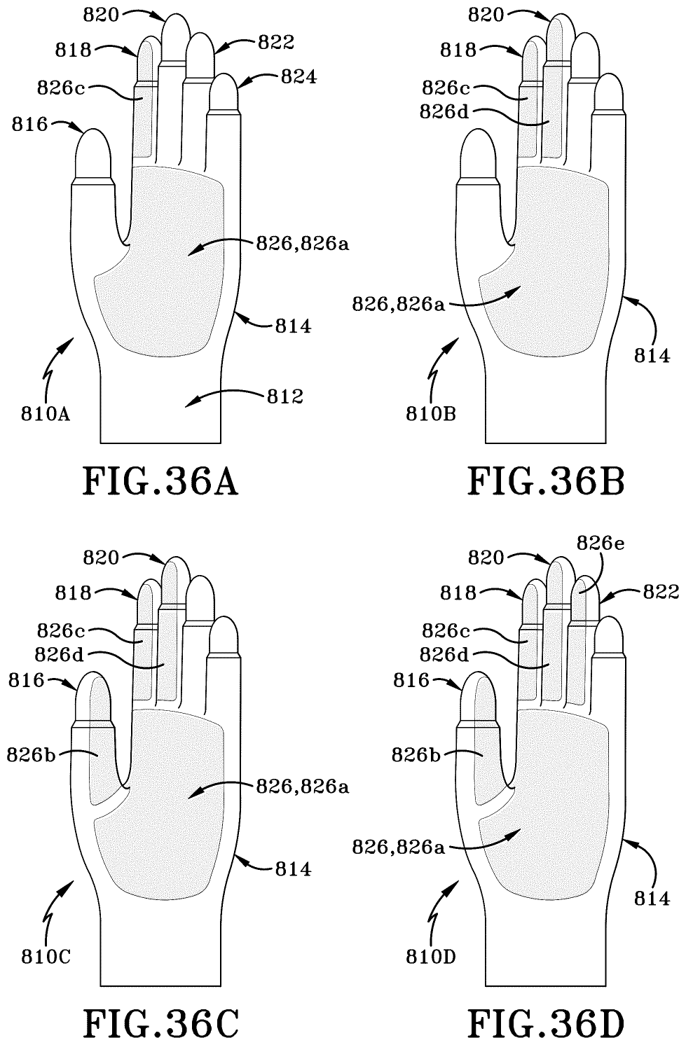

FIGS. 36A through 36D show alternative examples of the ninth embodiment glove 810, generally indicated as gloves 810A through 810D. FIGS. 36A through 36D show only the front of the alternative examples of the gloves 810A through 810D. The back of gloves 810A through 810D is not illustrated in the attached figures but should be understood to be substantially identical to the back of the glove shown in FIG. 34.

FIG. 36A shows a second example of the ninth embodiment glove, generally indicated at 810A. Glove 810A includes a first coated region 826a on palm region 814 and a third coated region 826c on index finger region 818. The rest of exterior surface of the front of glove 810A is free of any coating layer. It will be understood that while glove 810A shows a coated region on the palm region 814 and on the index finger region 818, in other embodiments any other one of the digit regions may have a coated region thereon instead of index finger region 818.

Glove 810B (FIG. 36B) shows a third example of the ninth embodiment glove and includes first coated region 826a on palm region 814, a third coated region 826c on index finger region 818, and a fourth coated region 826d on middle finger region 820. The rest of the exterior surface of the front of glove 810B is free of any coating layer. It will be understood that while glove 810A shows a coated region on the palm region 814 and on the index finger region 818 and middle finger region, in other embodiments any other two of the digit regions may have a coated region thereon instead of index finger region 818 and middle finger region 820.

FIG. 36C shows a fourth example of the ninth embodiment glove, generally indicated at 810C. Glove 810C includes a first coated region 826a on palm region 814, a second coated region 826b on thumb region 816, a third coated region 826c on index finger region 818, and a fourth coated region on middle finger region 820. The rest of the exterior surface of the front of glove 810C is free of any coating layer. It will be understood that while glove 810A shows a coated region on the palm region 814 and on the thumb region 816, the index finger region 818, and the middle finger region 820, in other embodiments any other three of the digit regions may be provided with coated regions thereon.

Glove 810D (FIG. 36D) includes a first coated region 826a on palm region 814, a second coated region 826b on thumb region 816, a third coated region 826c on index finger region 818, a fourth coated region 826d on middle finger region 820, and a fifth coated region 826e on ring finger region 822. The rest of the front of gloves 810D is free of coating regions thereon and is indicated by the reference number 827. It will be understood that while glove 810A shows a coated region on the palm region 814 and on the thumb region 816, the index finger region 818, the middle finger region 820, and the ring finger region 822, in other embodiments any other combination of four of the digit regions may be provided with coated regions thereon.

Gloves 810A through 810D are substantially identical in all other aspects of construction and function to glove 10.

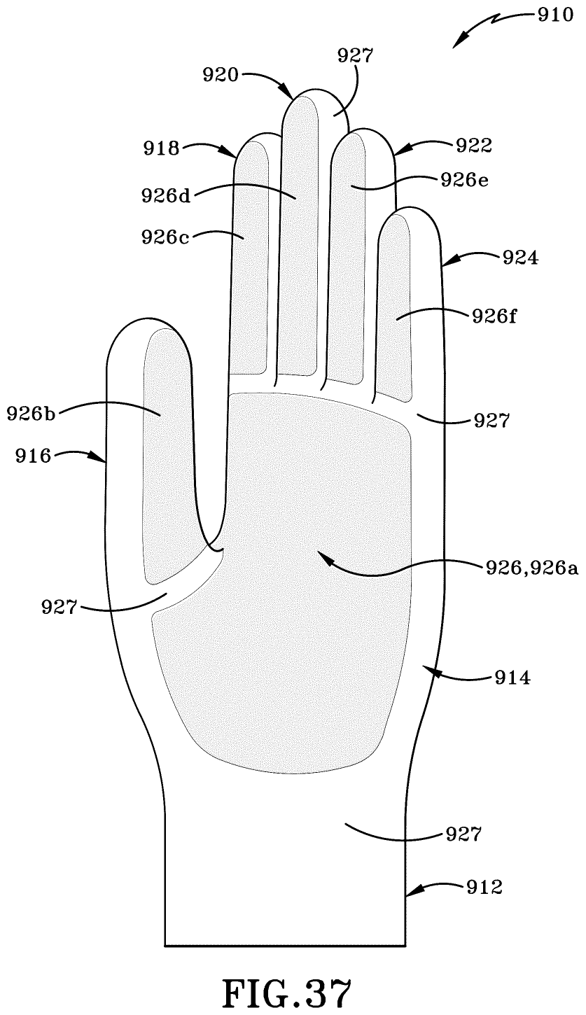

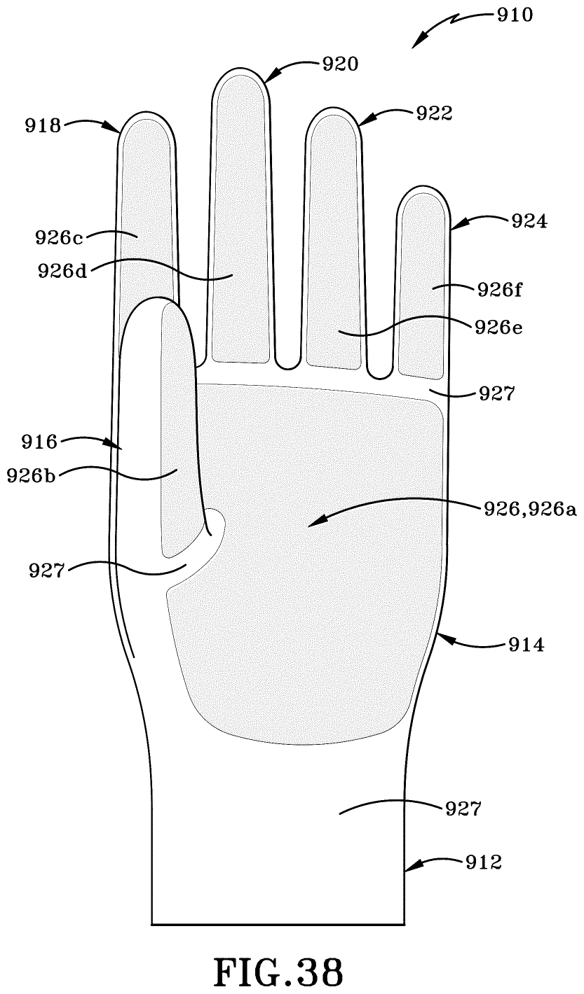

Referring now to FIGS. 37 to 40D there is shown a first example of a tenth embodiment of a glove in accordance with the present disclosure, generally indicated at 910. Glove 910 is substantially identical in structure and function to glove 810, except in the ways which will be discussed hereafter. Glove 910, like glove 810, is a hand-specific glove. Glove 910 comprises a wrist region 912, a palm region 914, a thumb region 916, an index finger region 918, a middle finger region 920, a ring finger region 922, and a little finger region 924. Glove 910 defines an interior cavity (not numbered) which is configured to receive a hand of a person therein.

Glove 910 differs from glove 810 in that instead of each digit region 916 through 924 including a reduced circumference fingertip region, a flaring transition region, and a remaining portion, the various digit regions in glove 910 are all of a substantially constant circumference along their lengths.

Glove 910, like glove 10, includes a plurality of coated regions on the palm region 914 and digit region 916 through 924. Palm region 914 includes a first coated region 926a which covers the gripping surface of palm region 914. The front surface of thumb region 916 includes a second coated region 926b, the front surface of index finger region 918 includes a third coated region 926c, the front surface of middle finger region 920 includes a fourth coated region 926d; the front surface of ring finger region 922 includes a fifth coated region 926e, and the front surface of little finger region 924 includes a sixth coated region 926f. Each of the coated regions 926b through 926f extends from proximate the palm region 914 of glove 910 to proximate a tip of the associated thumb region or finger region.

Glove 910, like glove 810, has a back which is free of any coating layer on the palm region 914 and digit regions 916 through 924. This is best seen in FIG. 34. The coating free exterior surface of the back of the glove 910 is indicated by the reference number 927.

A region free of the opioid/drug detected coating is located between first coated region 926a on palm region 914 and the second coated region 926b on thumb region 916. The region which is free of the coating is indicated by the reference number 927. Similarly, a coating-free region 927 is provided between the third coated region 926c on index finger region 918 and first coated region 926a on the front of palm region 914, and between the fourth coated region 926d on middle finger region 920 and first coated region 926a; and between the fifth coated region 926e on ring finger region 922 and first coated region 926a; and between the sixth coated region 926f on little finger region 924 and first coated region 926a on the front of palm region 914. The left and right sides of each of the thumb region 916, index finger region 918, middle finger region 920, ring finger region 922, and little finger region 924 are all free of the coating layer. The coating free regions 927 are substantially continuous with one another.

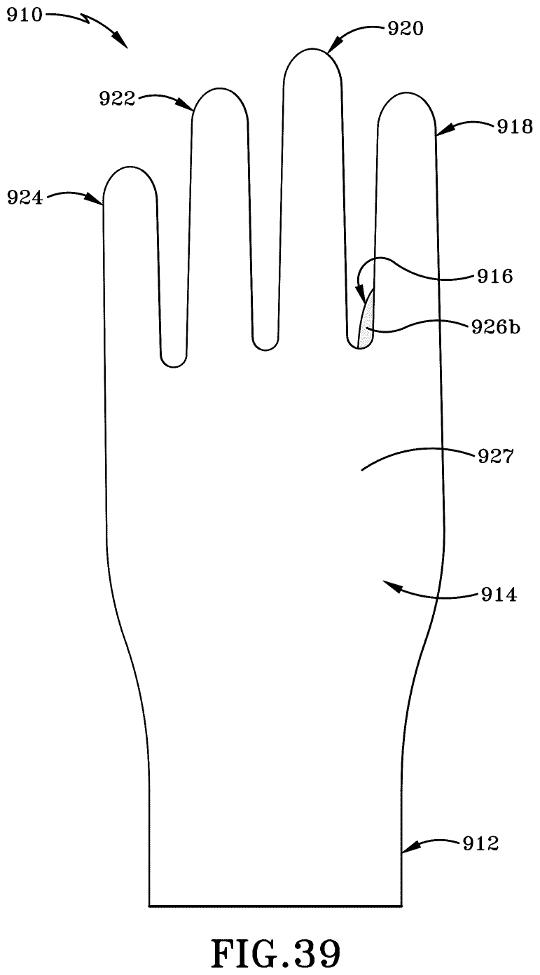

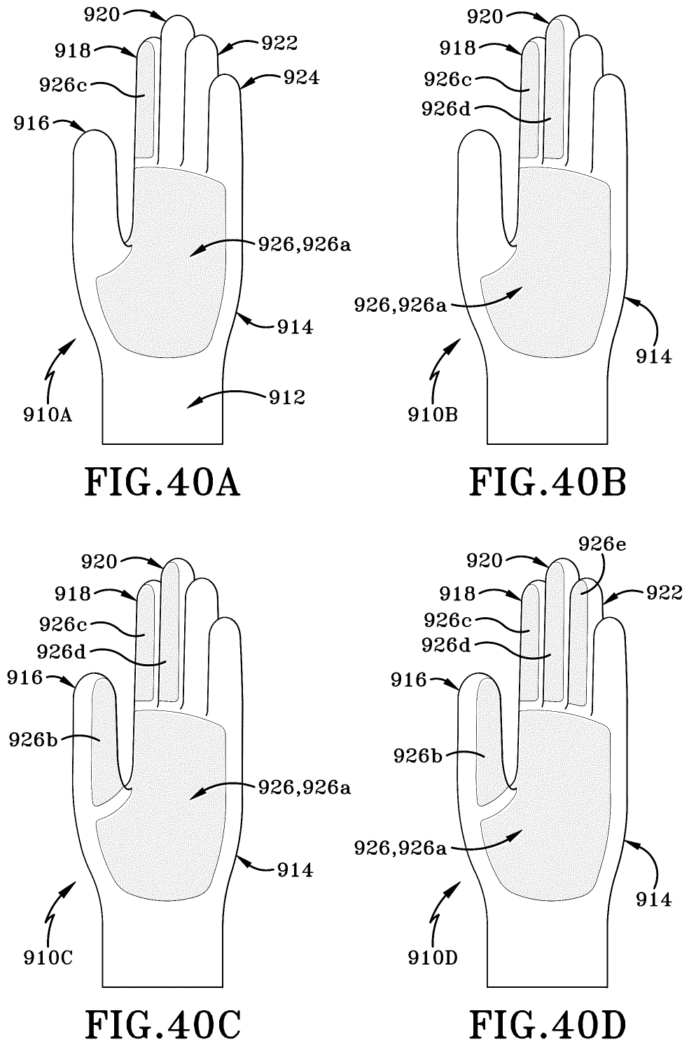

FIGS. 40A through 40D show alternative examples of the tenth embodiment glove 910, generally indicated as gloves 910A through 910D. FIGS. 40A through 40D show only the front of the alternative examples of the gloves 910A through 910D. The back of gloves 910A through 910D is not illustrated in the attached figures but should be understood to be substantially identical to the back of the glove shown in FIG. 39.

FIG. 40A shows a second example of the tenth embodiment glove, generally indicated at 910A. Glove 910A includes a first coated region 926a on palm region 914 and a third coated region 926c on index finger region 918. The rest of exterior surface of the front of glove 910A is free of any coating layer. It will be understood that while glove 910A shows a coated region on the palm region 914 and on the index finger region 918, in other embodiments any other one of the digit regions may have a coated region thereon instead of index finger region 918.

Glove 910B (FIG. 40B) shows a third example of the tenth embodiment glove and includes first coated region 926a on palm region 914, a third coated region 926c on index finger region 918, and a fourth coated region 926d on middle finger region 920. The rest of the exterior surface of the front of glove 910B is free of any coating layer. It will be understood that while glove 910A shows a coated region on the palm region 914 and on the index finger region 918 and middle finger region, in other embodiments any other two of the digit regions may have a coated region thereon instead of index finger region 918 and middle finger region 920.

FIG. 40C shows a fourth example of the tenth embodiment glove, generally indicated at 910C. Glove 910C includes a first coated region 926a on palm region 914, a second coated region 926b on thumb region 916, a third coated region 926c on index finger region 918, and a fourth coated region on middle finger region 920. The rest of the exterior surface of the front of glove 910C is free of any coating layer. It will be understood that while glove 910A shows a coated region on the palm region 914 and on the thumb region 916, the index finger region 918, and the middle finger region 920, in other embodiments any other three of the digit regions may be provided with coated regions thereon.

Glove 910D (FIG. 40D) includes a first coated region 926a on palm region 914, a second coated region 926b on thumb region 916, a third coated region 926c on index finger region 918, a fourth coated region 926d on middle finger region 920, and a fifth coated region 926e on ring finger region 922. The rest of the front of gloves 910D is free of coating regions thereon and is indicated by the reference number 927. It will be understood that while glove 910A shows a coated region on the palm region 914 and on the thumb region 916, the index finger region 918, the middle finger region 920, and the ring finger region 922, in other embodiments any other combination of four of the digit regions may be provided with coated regions thereon.

Gloves 910A through 910D are substantially identical in all other aspects of construction and function to glove 910 and thereby to glove 10.

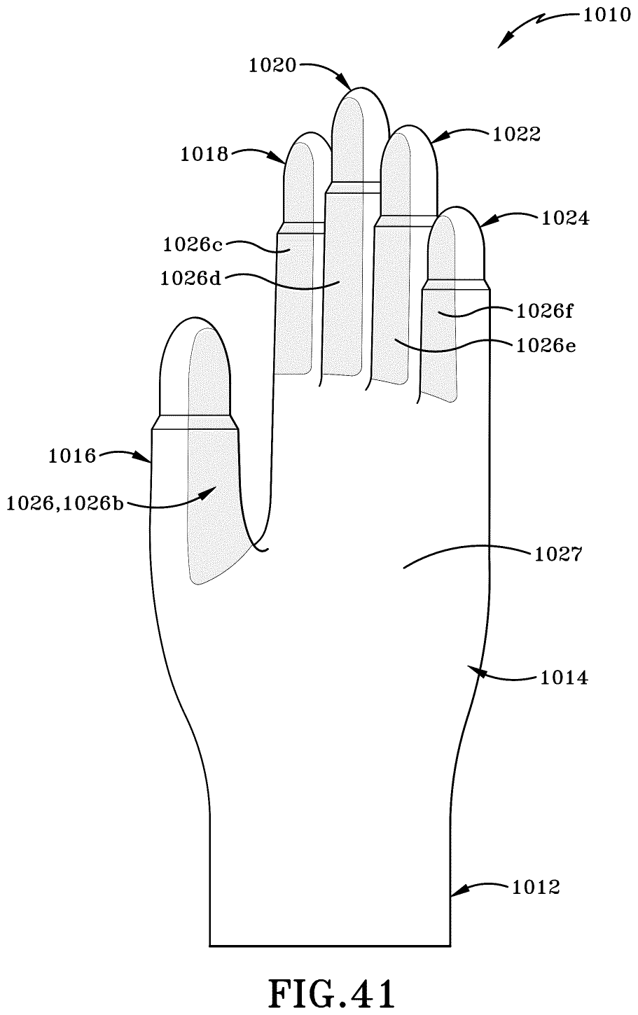

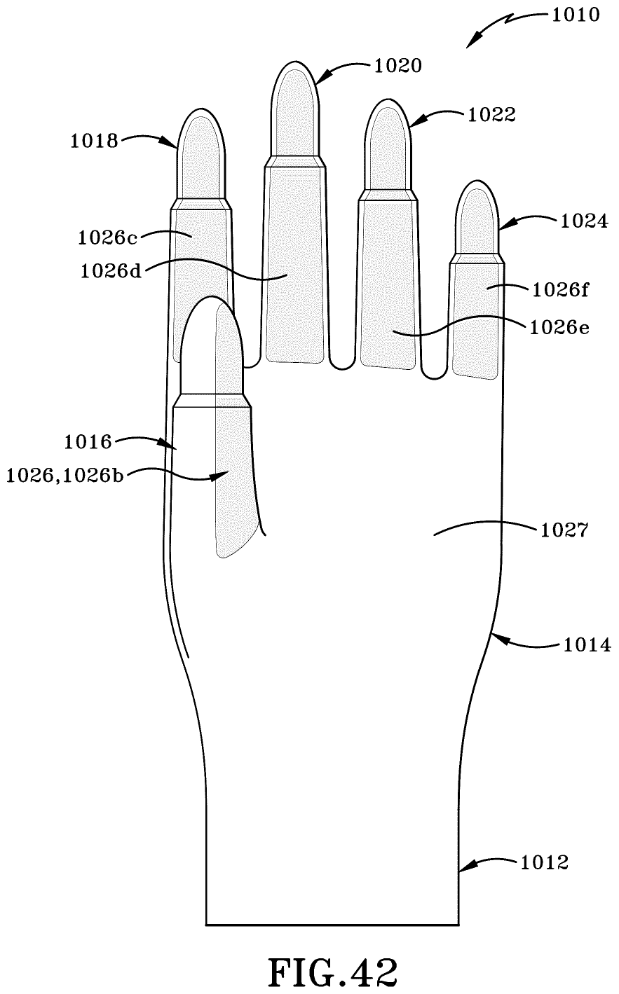

Referring now to FIGS. 41 to 44D there is shown an eleventh embodiment of a glove in accordance with the present disclosure, generally indicated by the reference number 1010. Glove 1010 is substantially identical in structure and function to glove 210 except for the differences discussed hereafter. Glove 1010 comprises a wrist region 1012, a palm region 1014, a thumb region 1016, an index finger region 1018, a middle finger region 1020, a ring finger region 1022, and a little finger region 1024. Glove 1010 defines an interior cavity (not numbered) which is configured to receive a hand of a person therein. The palm region 1014 includes a front which will be located adjacent those regions of a person's palm which will contact an object when gripped in the person's hand.

Unlike glove 210, glove 1010 is a hand-specific glove. Like glove 210, each of the digit regions 1016 through 1024 of glove 1010 has a fingertip region, a transition region and a remaining portion defined therein which are identical to the fingertip region, transition region and remaining portion of the digit regions 16 through 24 of glove 10.

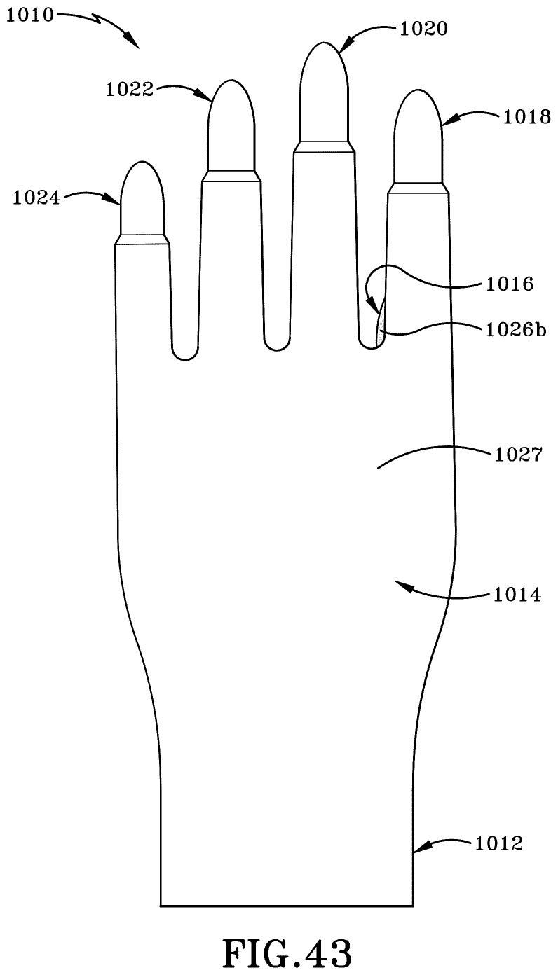

Referring still to FIGS. 41-44D, glove 1010 includes a plurality of coated regions which are capable of detecting and indicating the presence of dangerous drugs and chemicals to the person wearing the glove 1010. In particular, coated regions, generally indicated by the reference number 1026, are provided on the front of the glove 1010. Unlike glove 210, glove 1010 does not include any coated regions on the back of the glove. This is shown in FIG. 43. Like glove 210, glove 1010 does not include a coated region on palm region 1014. Like glove 210, glove 1010 does include, on the front surface of thumb region 1016, a second coated region 1026b. The front surface of index finger region 1018 includes a third coated region 1026c, the front surface of middle finger region 1020 includes a fourth coated region 1026d; the front surface of ring finger region 1022 includes a fifth coated region 1026e, and the front surface of little finger region 1024 includes a sixth coated region 1026f. Each of the coated regions 1026b through 1026f is formed and located on the front of glove 1010 in a substantially identical manner to coated regions 226a through 226f on glove 210.

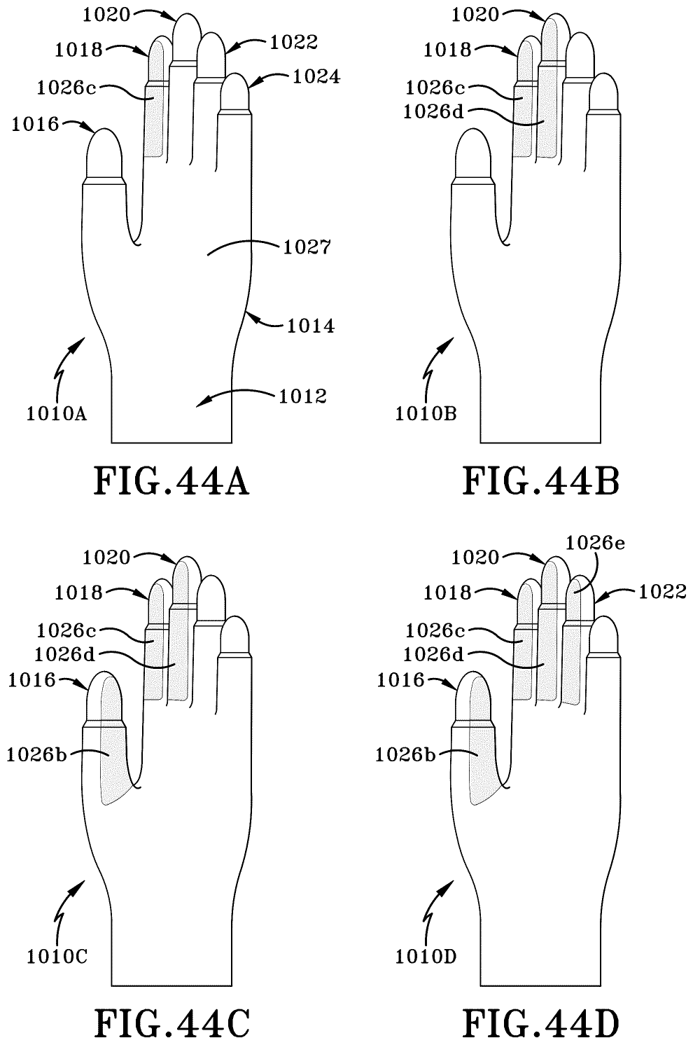

FIGS. 44A through 44D show alternative examples of the first embodiment glove 1010, generally indicated as gloves 1010A through 1010D. FIGS. 44A through 44D show only the front of the alternative examples of the gloves 1010A through 1010D. The back of gloves 1010A through 1010D is not illustrated in the attached figures but should be understood to be substantially identical in to the back of glove 1010 shown in FIG. 43.

FIG. 44A shows a second example of the eleventh embodiment glove, generally indicated at 1010A. Glove 1010A includes a third coated region 1026c on index finger region 1018. It will be understood that while glove 1010A shows a coated region on the index finger region 1018, in other embodiments any other one of the digit regions 1016 through 1024 may be provided with a coated region thereon.

Glove 1010B (FIG. 44B) shows a third example of the eleventh embodiment glove and includes a third coated region 1026c on index finger region 1018, and a fourth coated region 1026d on middle finger region 1020. It will be understood that while glove 1010B shows a coated region on the index finger region 1018 and the middle finger region 1020, in other embodiments any other two of the digit regions may be provided with coated regions thereon.

FIG. 44C shows a fourth example of the eleventh embodiment glove, generally indicated at 1010C. Glove 1010C includes a second coated region 1026b on thumb region 1016, a third coated region 1026c on index finger region 1018, and a fourth coated region on middle finger region 1020. It will be understood that while glove 1010C shows a coated region on the thumb region 1016, the index finger region 1018 and the middle finger region 1020, in other embodiments any other three of the digit regions may be provided with coated regions thereon.

Glove 1010D (FIG. 44D) includes a second coated region 1026b on thumb region 1016, a third coated region 1026c on index finger region 1018, a fourth coated region 1026d on middle finger region 1020, and a fifth coated region 1026e on ring finger region 1022. It will be understood that while glove 1010D shows a coated region on the thumb region 1016, the index finger region 1018, the middle finger region 1020, and the ring finger region 1022, in other embodiments any other four of the digit regions may be provided with coated regions thereon.

The rest of the exterior surface of the front and back of the gloves 1010A through 1010D is free of any coating layer. The uncoated exterior surface of the gloves 1010A through 1010D is indicated by the reference number 1027 in FIGS. 44A through 44D. Gloves 1010A through 1010D are substantially identical in all other aspects of construction and function as glove 10.

Referring now to FIGS. 15 to 17D there is shown a twelfth embodiment of a glove in accordance with the present disclosure, generally indicated by the reference number 1110. Glove 1110 is substantially identical in structure and function to glove 310 except for the differences discussed hereafter. Glove 1110 comprises a wrist region 1112, a palm region 1114, a thumb region 1116, an index finger region 1118, a middle finger region 1120, a ring finger region 1122, and a little finger region 1124. Glove 1110 defines an interior cavity (not numbered) which is configured to receive a hand of a person therein.

Glove 1110 differs from glove 310 in that glove 1110 is a hand-specific glove instead of being an ambidextrous glove. Like glove 310, glove 1110 does not have a fingertip region, a transition region and a remaining portion provided on each of the digit regions 1116 through 1124. Like glove 310, glove 1110 has digit regions 1116 through 1124 which are of substantially constant circumference from proximate the palm region 1114 to proximate a tip of the associated digit region 1116 through 1124.

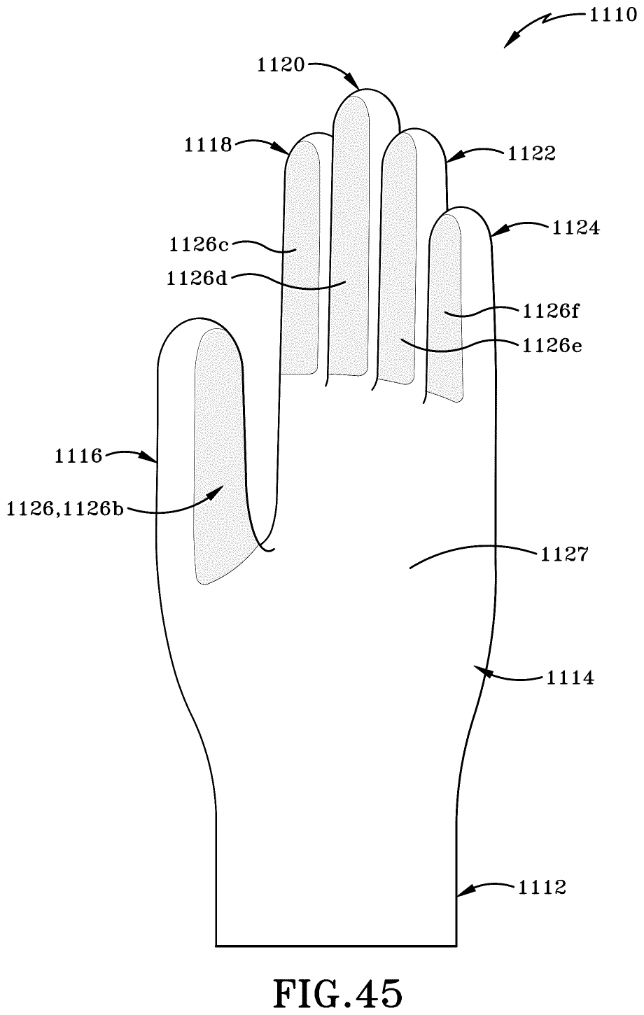

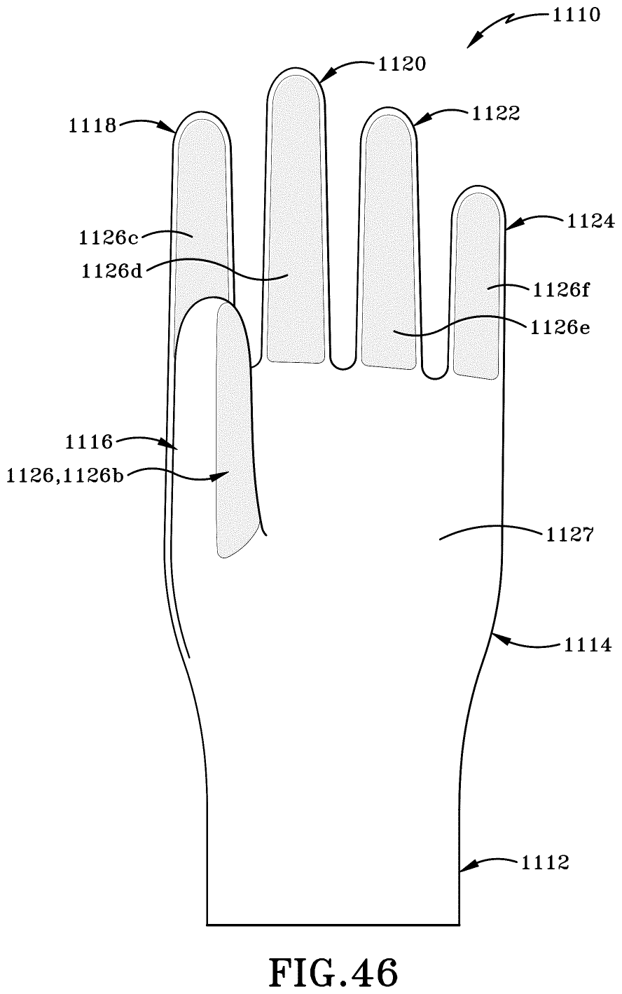

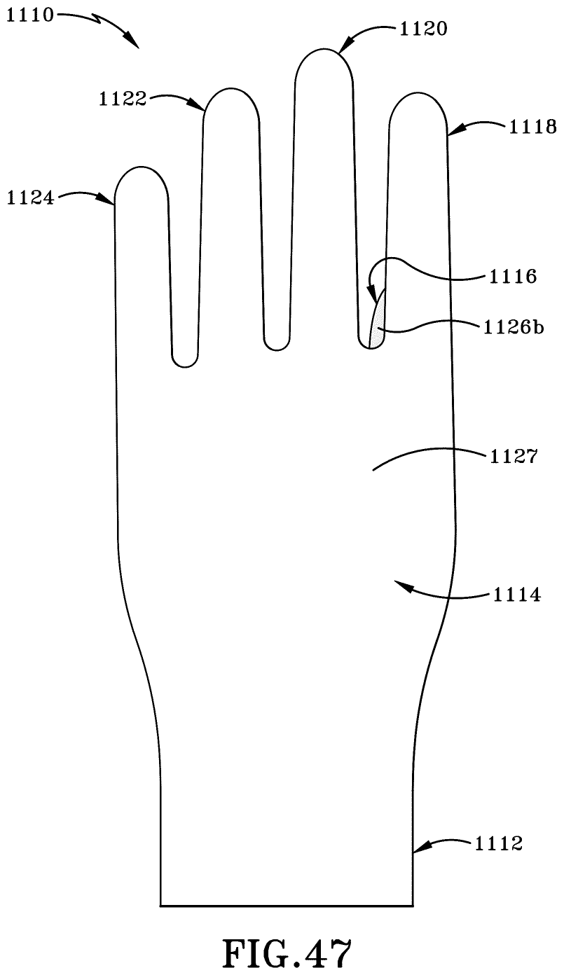

Referring still to FIGS. 45 to 48D, glove 1110 includes a plurality of coated regions on the digit regions 1116 through 1124 which are capable of detecting and indicating the presence of dangerous drugs and chemicals to the person wearing the glove 1110. In particular, coated regions, generally indicated by the reference number 1126, are provided on the front of the glove 1110. Like glove 310, glove 1110 does not include a coated region on the palm region 1114. Glove 1110 differs from glove 310 in that the back of glove 1110 is free of any coated regions.

Like glove 310, glove 1110 does include, on the front surface of thumb region 1116, a second coated region 1126b. The front surface of index finger region 1118 includes a third coated region 1126c, the front surface of middle finger region 1120 includes a fourth coated region 1126d; the front surface of ring finger region 1122 includes a fifth coated region 1126e, and the front surface of little finger region 1124 includes a sixth coated region 1126f. Each of the coated regions 1126b through 1126f is formed and located on the front of glove 1110 in a substantially identical manner to coated regions 326b through 326f on glove 310.

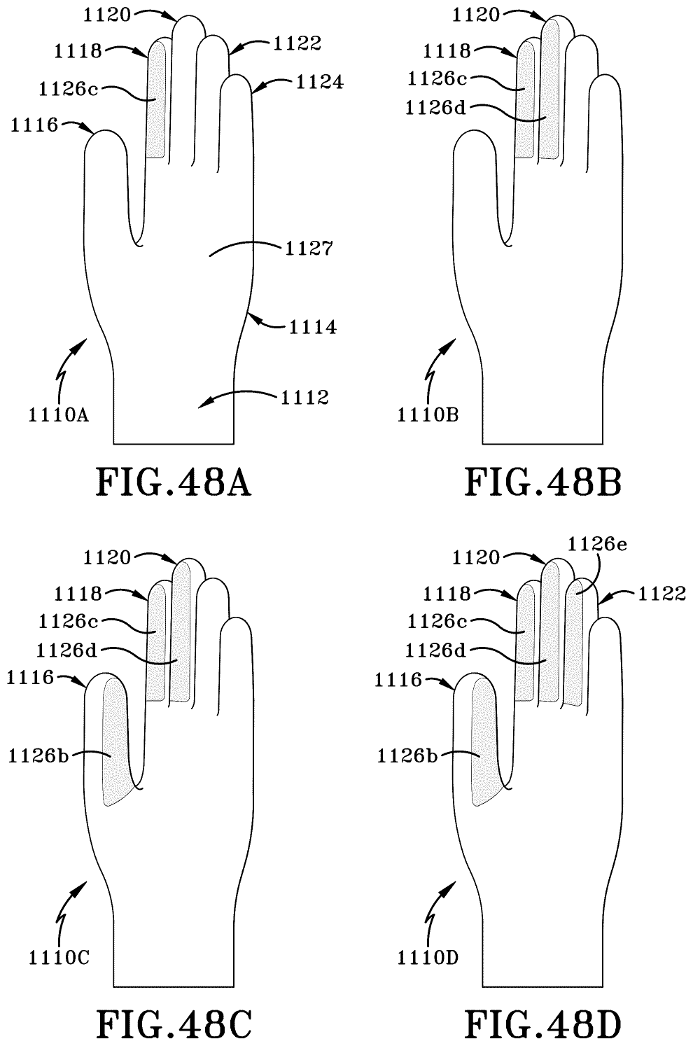

FIGS. 48A through 48D show alternative examples of the twelfth embodiment glove 1110, generally indicated as gloves 1110A through 1110D. FIGS. 48A through 48D show only the fronts of the alternative examples of the gloves 1110A through 1110D. The back of gloves 1110A are not illustrated in the attached figures but should be understood to be free of any coated regions thereon.

FIG. 48A shows a second example of the twelfth embodiment glove, generally indicated at 1110A. Glove 1110A includes a third coated region 1126c on index finger region 1118. It will be understood that while glove 1110A shows a coated region on the index finger region 1118, in other embodiments any other one of the digit regions may be provided with a coated region thereon.

Glove 1110B (FIG. 48B) shows a third example of the twelfth embodiment glove and includes a third coated region 1126c on index finger region 1118, and a fourth coated region 1126d on middle finger region 1120. It will be understood that while glove 1110B shows a coated region on the index finger region 1118 and the middle finger region 1120, in other embodiments any other two of the digit regions may be provided with coated regions thereon.

FIG. 48C shows a fourth example of the twelfth embodiment glove, generally indicated at 1110C. Glove 1110C includes a second coated region 1126b on thumb region 1116, a third coated region 1126c on index finger region 1118, and a fourth coated region on middle finger region 1120. It will be understood that while glove 1110C shows a coated region on the thumb region 1116, the index finger region 1118, and the middle finger region 1120, in other embodiments any other three of the digit regions may be provided with coated regions thereon.

Glove 1110D (FIG. 48D) includes a second coated region 1126b on thumb region 1116, a third coated region 1126c on index finger region 1118, a fourth coated region 1126d on middle finger region 1120, and a fifth coated region 1126e on ring finger region 1122. The rest of the exterior surface of the front of glove 1110D is free of any coating layer. It will be understood that while glove 1110D shows a coated region on the thumb region 1116, the index finger region 1118, the middle finger region 1120, and the ring finger region 1122, in other embodiments any other four of the digit regions may be provided with coated regions thereon.

The rest of the exterior surface of the front and back of gloves 1110A through 1110D is indicated by the reference number 1127 in FIGS. 48A through 48D as being free of any coated region that is able to detect and indicate that the glove has come into contact with a dangerous substance. Gloves 1110A through 1110D are substantially identical in all other aspects of construction and function as glove 10.

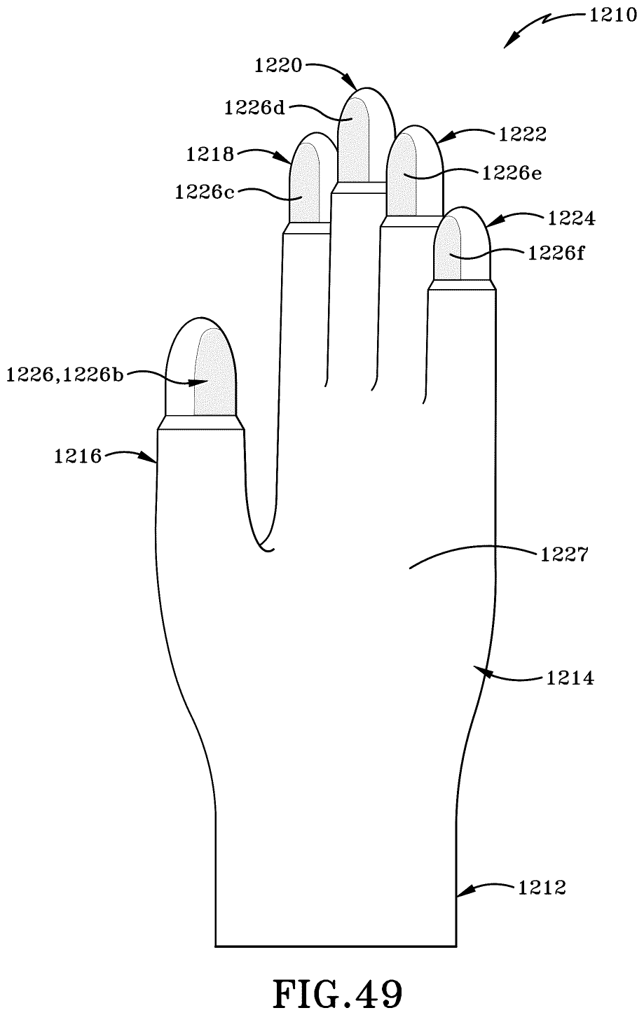

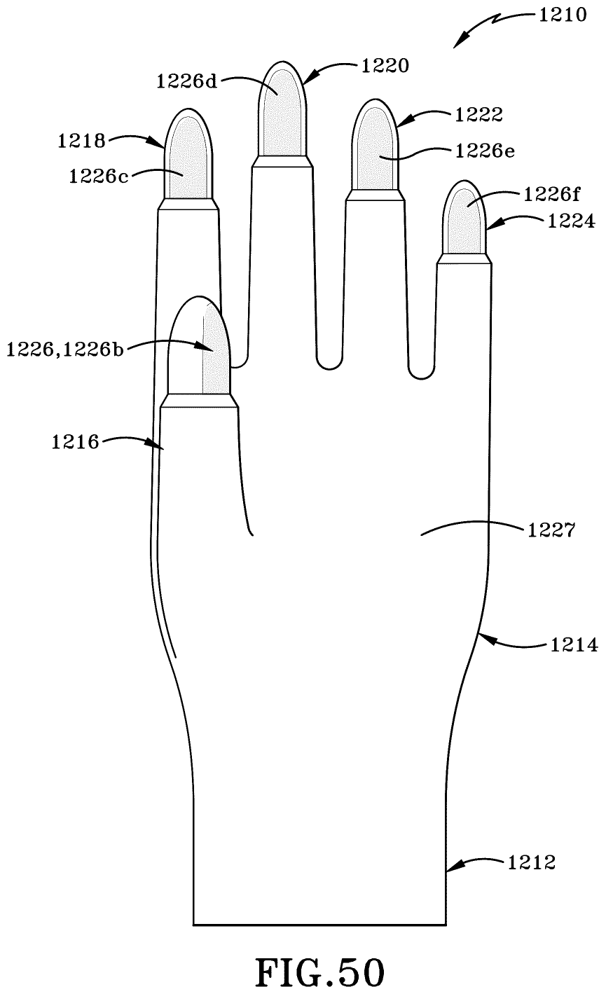

Referring now to FIGS. 49 through 52D, there is shown a thirteenth embodiment of a glove in accordance with the present disclosure, generally indicated at 1210. Glove is substantially identical to glove 410 in all aspects of construction and function except for the features discussed herein. Glove 1210 comprises a wrist region 1212, a palm region 1214, a thumb region 1216, an index finger region 1218, a middle finger region 1220, a ring finger region 1222, and a little finger region 1224. Glove 1210 defines an interior cavity (not numbered) which is configured to receive a hand of a person therein.

Unlike glove 410, glove 1210 is a hand-specific glove configured to be worn on a person's left hand. Similar to glove 410, each of the digit regions 1216 through 1224 of glove 1210 has a fingertip region, a transition region and a remaining portion provided therein which are identical to the fingertip region, transition region and remaining portion of the digit regions 416 through 424 of glove 410.

Referring still to FIGS. 49 to 52D, glove 1210 includes a plurality of coated regions which are capable of detecting and indicating the presence of dangerous drugs and chemicals to the person wearing the glove 1210. Glove 1210, like glove 410, in that only the fingertip regions of each of the digit regions 1216 through 1224 is provided with coated regions. Like glove 410, glove 1210 does include, on the front surface of the fingertip region of the thumb region 1216, a second coated region 1226b. The front surface of the fingertip region of the index finger region 1218 includes a third coated region 1226c, the front surface of the fingertip region of the middle finger region 1220 includes a fourth coated region 1226d; the front surface of the fingertip region of the ring finger region 1222 includes a fifth coated region 1226e, and the front surface of the fingertip region of the little finger region 1224 includes a sixth coated region 1226f. Each of the coated regions 1226b through 1226f is formed and located on the front of the fingertip regions of glove 1210 in a substantially identical manner to the coated regions 426b through 426f on glove 410.

Unlike glove 410, glove 1210 does not include a plurality of coated regions on the back of the fingertip regions of the digit regions 1216 through 1224 of glove 1210. All of the back of glove 1210 is free of coated regions. This is indicated by the reference number 1227.

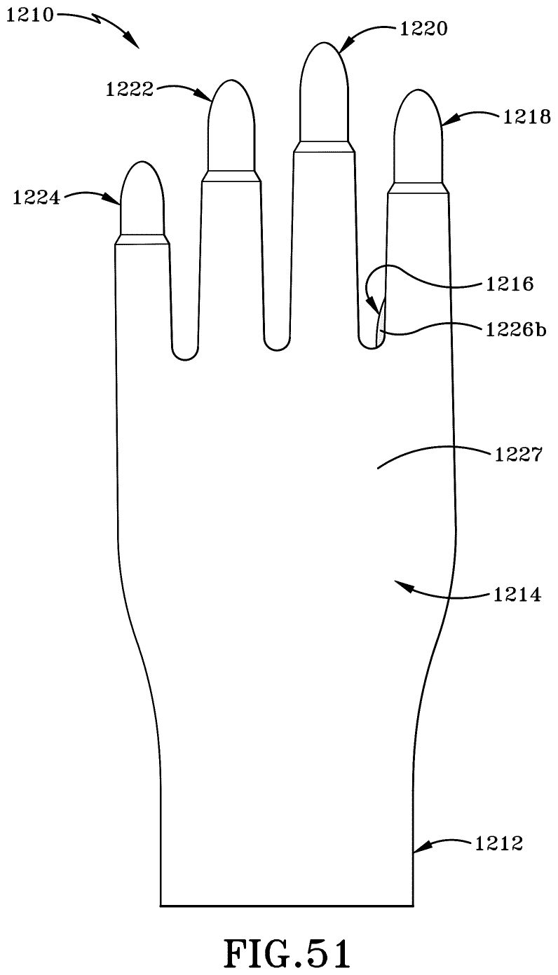

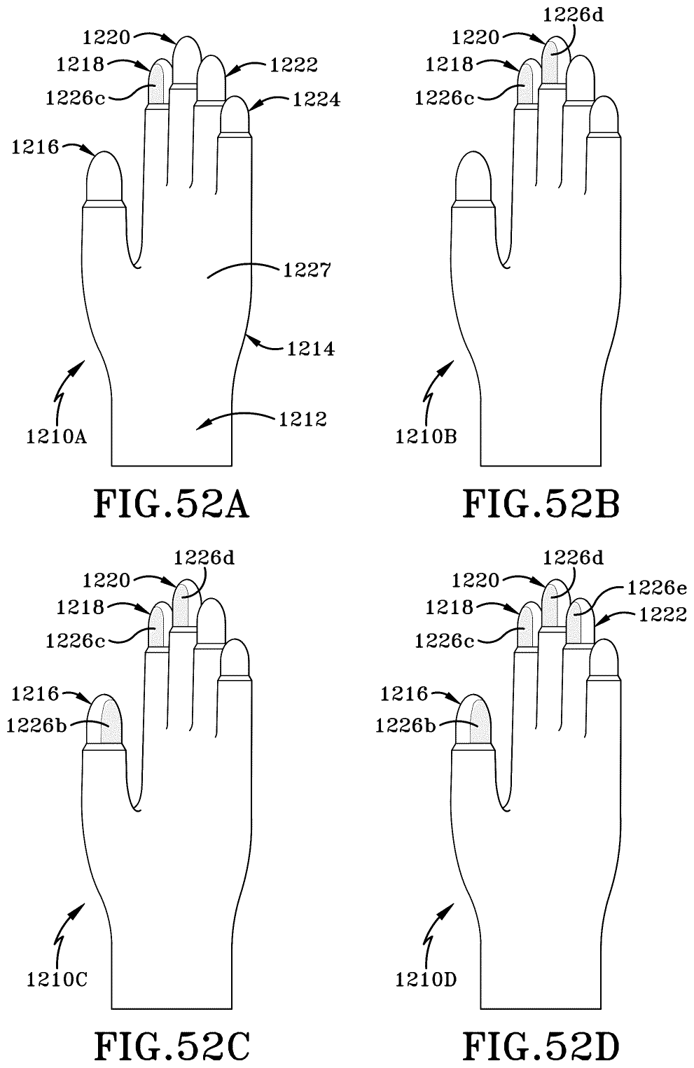

FIGS. 52A through 52D show alternative examples of the thirteenth embodiment glove 1210, generally indicated as gloves 1210A through 1210D. FIGS. 52A through 52D show only the front of the alternative examples of the gloves 1210A through 1210D. The backs of gloves 1210A through 1210D are not illustrated in the attached figures but they should be understood to be free of any coated regions thereon, similar to FIG. 51.

FIG. 52A shows a second example of the thirteenth embodiment glove, generally indicated at 1210A. Glove 1210A includes a third coated region 1226c on the fingertip region of index finger region 1218. It will be understood that while glove 1210A shows a coated region on the fingertip region of the index finger region 1218, in other embodiments any other one of the fingertip regions of the digit regions may be provided with a coated region on the fingertip region thereof.

Glove 1210B (FIG. 52B) shows a third example of the thirteenth embodiment glove and includes a third coated region 1226c on the fingertip region of index finger region 1218, and a fourth coated region 1226d on the fingertip region of finger region 1220. It will be understood that while glove 1210B shows a coated region on the fingertip region of the index finger region 1218 and the middle finger region 1220, in other embodiments any other two of the digit regions may be provided with coated regions on the fingertip regions thereof.

FIG. 52C shows a fourth example of the thirteenth embodiment glove, generally indicated at 1210C. Glove 1210C includes a second coated region 1226b on the fingertip region of thumb region 1216, a third coated region 1226c on the fingertip region of index finger region 1218, and a fourth coated region on the fingertip region of middle finger region 1220. It will be understood that while glove 1210C shows a coated region on the thumb region 1216, the index finger region 1218, and the middle finger region 1220, in other embodiments any other three of the digit regions may be provided with coated regions on the fingertip regions thereof.

Glove 1210D (FIG. 52D) includes a second coated region 1226b on the fingertip region of thumb region 1216, a third coated region 1226c on the fingertip region of index finger region 1218, a fourth coated region 1226d on the fingertip region of middle finger region 1220, and a fifth coated region 1226e on the fingertip region of ring finger region 1222. It will be understood that while glove 1210D shows a coated region on the thumb region 1216, the index finger region 1218, the middle finger region 1220, and the ring finger region 1222, in other embodiments any other four of the digit regions may be provided with coated regions on the fingertip regions thereof.

The rest of the exterior surface of the fronts of gloves 1210A through 1210D and the backs thereof are free of any coating layer. This is indicated by the reference number 1227 in FIGS. 52A through 52D. Gloves 1210A through 1210D are substantially identical in all other aspects of construction and function to glove 10.

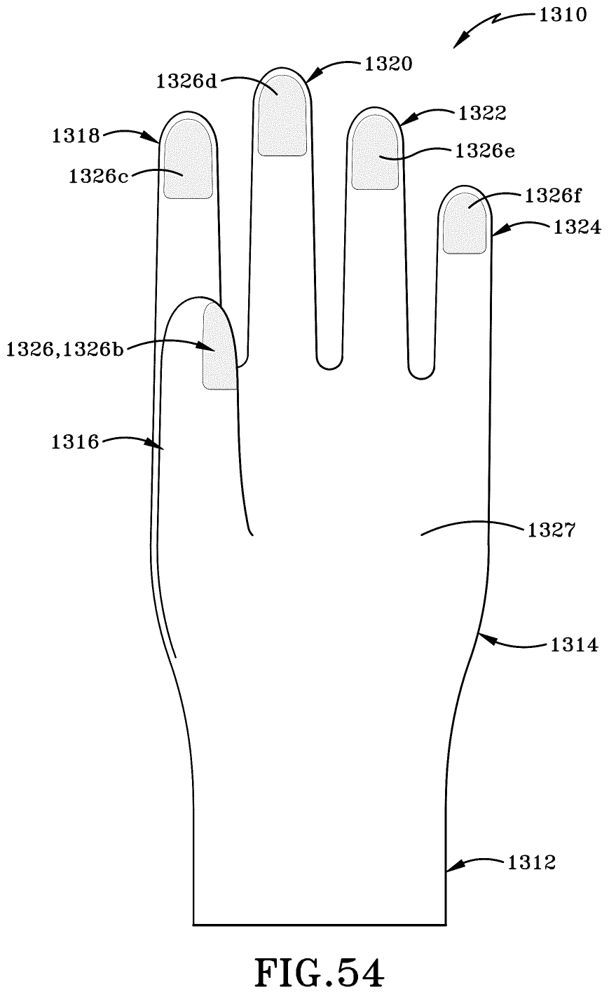

Referring now to FIGS. 53 to 56D there is shown a fourteenth embodiment of a glove in accordance with the present disclosure, generally indicated by the reference number 1310. Glove 1310 is substantially identical in structure and function to glove 510 except for the differences discussed hereafter. Glove 1310 comprises a wrist region 1312, a palm region 1314, a thumb region 1316, an index finger region 1318, a middle finger region 1320, a ring finger region 1322, and a little finger region 1324. Glove 1310 defines an interior cavity (not numbered) which is configured to receive a hand of a person therein.

Glove 1310, unlike glove 510, is a hand-specific glove instead of an ambidextrous glove. Glove 1310, like glove 510, has digit regions 1316 through 1324 which are of a substantially constant diameter along their lengths.

Referring still to FIGS. 53-56D, glove 1310 includes a plurality of coated regions which are capable of detecting and indicating the presence of dangerous drugs and chemicals to the person wearing the glove 1310. In particular, coated regions, generally indicated by the reference number 1326, are provided on the front of the glove 1310 but not on the back of the glove. In glove 1310, an upper portion of each digit region 1316 to 1324 includes a coated region. The upper portion originates at a tip of the associated digit region and extends downwardly toward the palm region 1314. The upper portion and the coated region on that upper portion terminates proximate where a person's first knuckle will be located when glove 1310 is worn. Glove 1310 does not include any other coated regions thereon.

On glove 1310 the front of the thumb region 1316 includes a second coated region 1326b on the upper portion thereof, the index finger region 1318 includes a third coated region 1326c on an upper portion thereof, the middle finger region 1320 includes a fourth coated region 1326d on an upper portion thereof, the ring finger region 1326d includes a fifth coated region 1326e on an upper portion thereof, and the little finger region 1324 includes a sixth coated region 1326f on an upper portion thereof. The uncoated rest of the glove 1310 is therefore indicated by the reference number 1327.

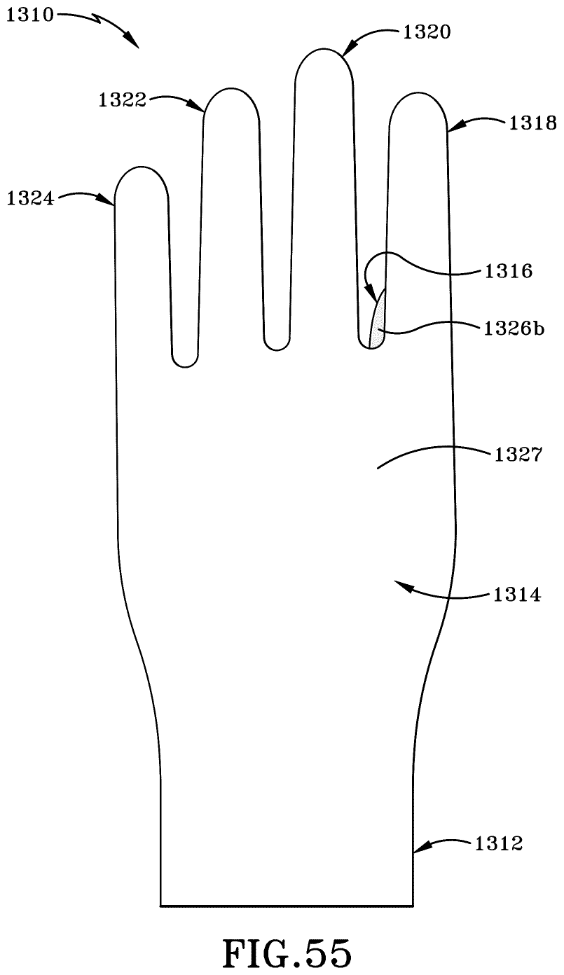

FIGS. 56A through 56D show alternative examples of the fourteenth embodiment glove 1310, generally indicated as gloves 1310A through 1310D. FIGS. 56A through 56D show only the front of the alternative examples of the gloves 1310A through 1310D. The backs of gloves 1310A through 1310D are not illustrated in the attached figures but they should be understood to be substantially identical to the back of glove 1310 shown in FIG. 55.

FIG. 56A shows a second example of the fourteenth embodiment glove, generally indicated at 1310A. Glove 1310A includes a third coated region 1326c on the upper portion of index finger region 1318. It will be understood that while glove 1310A shows a coated region on the upper portion of the index finger region 1318, in other embodiments any one other of the digit regions may be provided with a coated region on its upper portion.

Glove 1310B (FIG. 56B) shows a third example of the fourteenth embodiment glove and includes a third coated region 1326c on the upper portion of index finger region 1318, and a fourth coated region 1326d on the upper portion of finger region 1320. It will be understood that while glove 1310B shows a coated region on the upper portion of the index finger region 1318 and the middle finger region 1320, in other embodiments any other two of the digit regions may be provided with coated regions on their upper portions.

FIG. 56C shows a fourth example of the fourteenth embodiment glove, generally indicated at 1310C. Glove 1310C includes a second coated region 1326b on the upper portion of thumb region 1316, a third coated region 1326c on the upper portion of index finger region 1318, and a fourth coated region on the upper portion of middle finger region 1320. It will be understood that while glove 1310C shows a coated region on the thumb region 1316, the index finger region 1318, and the middle finger region 1320, in other embodiments any other three of the digit regions may be provided with coated regions on their upper portions.

Glove 1310D (FIG. 56D) includes a second coated region 1326b on the upper portion of thumb region 1316, a third coated region 1326c on the upper portion of index finger region 1318, a fourth coated region 1326d on the upper portion of middle finger region 1320, and a fifth coated region 1326e on the upper portion of ring finger region 1322. It will be understood that while glove 1310D shows a coated region on the upper portions of thumb region 1316, the index finger region 1318, the middle finger region 1320, and the ring finger region 1322, in other embodiments any other four of the digit regions may be provided with coated regions on their upper portions.

The rest of the exterior surface of the fronts of gloves 1310A through 1310D and the backs thereof are free of any coating layer. This is indicated by the reference number 1327 in FIGS. 56A through 56D. Gloves 1310A through 1310D are substantially identical in all other aspects of construction and function to glove 10.

Referring now to FIGS. 57 to 59 there is shown a fifteenth embodiment of a glove in accordance with the present disclosure, generally indicated by the reference number 1410. Glove 1410 is substantially identical in structure and function to glove 610 except for the differences discussed hereafter. Glove 1410 comprises a wrist region 1412, a palm region 1414, a thumb region 1416, an index finger region 1418, a middle finger region 1420, a ring finger region 1422, and a little finger region 1424. Glove 1410 defines an interior cavity (not numbered) which is configured to receive a hand of a person therein. The palm region 1414 includes a front which will be located adjacent those regions of a person's palm which will contact an object when the object is gripped in the person's hand.

Glove 1410, unlike glove 610, is a hand-specific glove which is configured to be worn on a person's left hand. Glove 1410, like glove 610, includes narrower circumference fingertip regions and flaring transition regions on the digit regions 1416 through 1424.

Glove 1410, like glove 610, includes a first coated region 1426 on the front of palm region 1414. Glove 1410, like glove 610 does not include any other coated regions on the front of glove 1410. Glove 1410, unlike glove 610, does not include any coated regions on any other part of the back of glove 1410. The rest of the front and back of the glove 1410 which surrounds the coated region of palm region 1426 is free of any coating and is indicated by the reference number 1427.

Glove 1410 is substantially identical in all other aspects of construction and function to glove 10.

Referring now to FIGS. 60 to 62 there is shown a sixteenth embodiment of a glove in accordance with the present disclosure, generally indicated by the reference number 1510. Glove 1510 is substantially identical in structure and function to glove 710 except for the differences discussed hereafter. Glove 1510 comprises a wrist region 1512, a palm region 1514, a thumb region 1516, an index finger region 1518, a middle finger region 1520, a ring finger region 1522, and a little finger region 1524. Glove 1510 defines an interior cavity (not numbered) which is configured to receive a hand of a person therein. The palm region 1514 includes a front which will be located adjacent those regions of a person's palm which will contact an object when the object is gripped in the person's hand.

Glove 1510, unlike glove 710, is a hand-specific glove which is configured to be worn on a left hand of a person. Glove 1510, like glove 710, does not include narrower circumference fingertip regions and flaring transition regions on the digit regions 1516 through 1524. Instead, glove 1510 has digit regions 1516 through 1524 which are of a substantially constant diameter along their lengths.

Glove 1510, like glove 710, includes a first coated region 1526 on the front of palm region 1514 but unlike glove 710 does not have a first coated region on the back of palm region 1514. Glove 1510, like glove 710, does not include any coated regions on any of the digit regions. The rest of the front and back of the glove 1510 which surrounds the coated region 1526 is free of any coating and is indicated by the reference number 1527.

Glove 1510 is substantially identical in all other aspects of construction and function to glove 10.

While not illustrated in any of the embodiments disclosed herein, it will be understood that the wrist region (front and/or back) may also include a coated region capable of detecting, indicating and/or resisting dangerous drugs and chemicals.

In addition to including coated regions which are capable of detecting dangerous drugs and other toxic compounds and of indicating the detection of those drugs and compounds, the various embodiments of the gloves disclosed herein may be fabricated from a glove material which is resistant to the toxic drugs and chemicals it is formulated to detect, particularly those which include opioids. In these instances, the coated regions on the exterior surface of the glove will detect the dangerous substance and indicate to the person wearing the gloves that a dangerous substance has been contacted. Additionally, the glove material used to fabricate the glove will prevent the dangerous substance from penetrating the glove material and coming into contact with the person's skin.

In yet other embodiments, the material from which glove 10 is fabricated may include compounds which neutralize dangerous or toxic substances that may penetrate the glove material.

In yet other embodiments, the glove material is resistant to the substances the coating is formulated to detect but, in other embodiments, the glove material is not resistant to the substances the coating is formulated to detect. For example, the glove material may be opioid-resistant or the glove material may not be opioid-resistant.

In some embodiments, instead of only including a drug detection or drug resistant coating on a glove fabricated from a glove material that is not drug detecting or drug resistant, the glove may alternatively be fabricated from a glove material which is, itself, formulated to detect and indicate dangerous drugs or chemicals while being resistant to those dangerous substances. In some embodiments, the glove material may be formulated to detect, indicate, and be resistant to opioids or to compounds mixed with opioids. The glove material may be formulated to substantially prevent opioids or compounds including opioids to pass through the glove material from an exterior surface of the glove to an interior surface thereof. These substances to which the glove material may be resistant include drugs mixed with opioids. The opioids with respect to which the glove material is resistant include, but are not limited to, fentanyl, carfentanil, heroin (diacetylmorphine), morphine, oxycodone, buprenorphine, methadone, hydrocodone (dihydrocodeinone), meperidine, codeine, tramadol, and oxymorphone. The glove material may furthermore be resistant to drugs such as xylazine. Xylazine is a non-opioid sedative or tranquilizer. The glove material may furthermore be resistant to drugs such as xylazine mixed with an opioid. Additionally, the glove material may be resistant to bodily fluids such as gastric acid.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A method of detecting a toxic substance on a surface comprising:
providing a glove having an exterior surface;
formulating a coating capable of detecting the toxic substance;
applying the coating over at least a portion of the exterior surface of the glove;
donning the glove; and
detecting a drug by engaging the coating with the toxic substance.

2. The method according to claim 1, wherein formulating the coating includes formulating a coating capable of detecting an opioid or mixtures including an opioid.

3. The method according to claim 1, wherein formulating the coating includes formulating a coating capable of detecting one or more of fentanyl, carfentanil, and mixtures of drugs including fentanyl or carfentanil.

4. The method according to claim 1, wherein formulating the coating includes formulating a coating capable of detecting one or more of xylazine and xylazine mixed with an opioid.

5. The method according to claim 1, wherein detecting the drug comprises:
contacting a surface with the portion of the exterior surface of the glove having the coating applied thereto.

6. The method according to claim 1, wherein detecting the drug comprises:
changing a characteristic of the coating to indicate the presence of the toxic substance.

7. The method according to claim 6, wherein changing the characteristic of the coating includes changing a color of the coating from a first color to a second color when the toxic substance is detected.

8. The method according to claim 1, wherein detecting the drug occurs from physical contact between the coating and the toxic substance.

9. The method according to claim 1, further comprising:
providing a damage indicator on the glove.

10. The method according to claim 9, wherein providing the damage indicator on the glove comprises:
forming an interior surface of the glove of a first color;
changing the coating to a second color when the toxic substance is detected;
forming the exterior surface of glove with a third color; and
wherein the third color contrasts from the first and second colors.

11. The method according to claim 10, wherein the first color and the second color contrast one another to indicate to a user of the glove the coating has contacted the drug.

12. The method according to claim 10, further comprising:
indicating to a user of the glove is damaged when the user can visually observe the third color.

13. The method according to claim 1, wherein the glove and the coating are formed of a material resistant to the toxic substance.

14. The method according to claim 1, wherein applying the coating further comprises:
bonding the coating to at least the portion of the exterior surface of the glove.

15. The method according to claim 1, wherein applying the coating includes forming a coated region on one or more of a palm region and a digit region of the glove.

16. The method according to claim 1, wherein applying the coating includes forming a coated region on the palm region on one or both of a front and a back of the glove.

17. The method according to claim 1, wherein applying the coating includes forming a coated region on each digit region of the plurality of digit regions on one or both of a front and a back of the glove.

18. The method according to claim 1, wherein applying the coating includes forming a coated region on at least two digit regions of the plurality of digit regions on one or both of a front and a back of the glove.

19. The method according to claim 1, wherein applying the coating includes forming a coated region on an upper portion of at least one digit region of the plurality of digit regions which extends from proximate a tip of the at least one digit region to proximate where a first knuckle of a person's thumb or finger will be located when the glove is worn.

20. The method according to claim 1, wherein applying the coating includes forming a coated region over substantially the entire exterior surface of the glove.
